(19) United States
(12) Patent Application Publication
(10) Pub. No.: US 2011/0200789 A1
(43) Pub. Date: Aug. 18, 2011

(54) RETROREFLECTIVE PAVEMENT MARKINGS

(76) Inventors: Kenton D. Budd, Woodbury, MN (US); Matthew H. Frey, Cottage Grove, MN (US); Christopher K. Haas, St. Paul, MN (US); Vivek Krishnan, St. Paul, MN (US)

(21) Appl. No.: 12/808,492

(22) PCT Filed: Dec. 4, 2008
(86) PCT No.: PCT/US08/85462

§ 371 Date: Apr. 1, 2011

Related U.S. Application Data
(60) Provisional application No. 61/016,191, filed on Dec. 21, 2007.

(51) Int. Cl. B32B 3/00

(52) U.S. Cl. 428/145; 428/144

(57) ABSTRACT

Pavement markings having a substrate with a first major surface and a second major surface; and a plurality of retroreflective elements (100) disposed along the first major surface of the substrate, the retroreflective elements each having a solid spherical core (110) and at least a first complete concentric optical interference layer (120) overlying core. In some embodiments, the retroreflective elements of the pavement marking further include a second complete concentric optical interference layer overlying the first complete concentric optical interference layer. In still other embodiments, the retroreflective elements of the pavement markings further include a third complete concentric optical interference layer overlying the second complete concentric optical interference layer.

The present invention relates to pavement markings comprised of retroreflective elements having at least one complete concentric optical interference layer disposed over a solid spherical core.

### BACKGROUND

“Retroreflectivity” refers to the ability of an article, if engaged by a beam of light, to reflect that light substantially back in the direction of the light source. Retroreflective pavement markings are known and are used to mark roadways and other surfaces to indicate center and edge lines, crosswalks, construction zones, and the like. Beaded retroreflective articles, including beaded pavement markings, generally include a plurality of transparent spherically shaped beads or retroreflective elements affixed to at least one major surface of a substrate. Beaded pavement markings include articles applied as a sheet or as a tape in addition to articles applied as a paint or liquid. In beaded retroreflective constructions, substantially collimated light (e.g., a beam of light from an automobile headlight) enters the front surfaces of the beads, is refracted, and impinges on a reflector at or near the back surfaces of the beads. The optical characteristics of the beads and reflectors can be tailored so that a significant amount of light is returned antiparallel or nearly antiparallel to the incident light.

Pavement markings typically include reflectors derived from pigments. Pigments can be used as reflectors by dispersing them in a binder and coating the pigmented binder onto the back surface of a layer that comprises a plurality of retroreflective elements or by partially imbedding a layer of retroreflective elements directly in the pigmented binder. Reflective pigments include, for example, titania particles, mica flakes, other powders and the like. Conformal reflective coatings are also used in retroreflective articles, and are normally applied to the back side of the retroreflective elements (e.g., between the retroreflective elements and a substrate) in a planar construction. Conformal reflective coatings include metal thin films such as aluminum and silver, and dielectric coatings such as metal fluorides and zinc sulfide. Conformal reflective coatings are often considered less desirable for pavement markings due to high cost, metallic coloration, and other factors. Pavement markings are generally designed to appear uniformly white, or a single uniform color such as yellow.

Retroreflective elements having a single complete concentric optical interference layer coated over a solid spherical core are known to produce covert interference colors and retrochromic patterns. The term “retrochromic” refers to the ability of an article or a region thereof, when viewed in retroreflective mode, to exhibit a reflected color that is different from the color exhibited when the object or region is viewed in diffuse lighting. The art has also noted an effect of the refractive index of a single complete concentric optical interference layer on the saturation and intensity of retrochromic colors. It has been suggested that the medium behind the optical interference layer (e.g., between the retroreflective element and the substrate or backing) can provide a high refractive index contrast interface between the coating and the medium. The art suggests that a thicker coating applied to a retroreflective element already comprising a complete concentric optical interference layer, can be used to adjust the interference effect by fixing refractive index differences of the interfaces. The art has also noted that resulting retrochromic patterns are useful for security articles, decorative articles, and the like.

While retroreflective pavement markings have been commercially available for some time and have generally advanced the state of the art, improvements to the retroreflective properties of such articles represent a long felt need.

### SUMMARY

The present invention addresses the long felt need in the art by providing pavement markings with enhanced retroreflective properties and retroreflective color.

In one aspect, the invention provides a pavement marking, comprising:
A substrate having a first major surface and a second major surface; and
A plurality of retroreflective elements disposed along the first major surface of the substrate, the retroreflective elements each comprising:
   a solid spherical core comprising an outer core surface, the outer core surface providing a first interface;
   at least a first complete concentric optical interference layer having an inner surface overlying outer core surface and an outer surface, the outer surface of the first complete concentric optical interference layer providing a second interface.

In another aspect, the retroreflective elements further comprise:
A second complete concentric optical interference layer having an inner surface overlying the outer surface of the first complete concentric optical interference layer and an outer surface, the outer surface of the second complete concentric optical interference layer providing a third interface.

In still another aspect of the invention, the retroreflective elements further comprise:
A third complete concentric optical interference layer having an inner surface overlying the outer surface of the second complete concentric optical interference layer and an outer surface, the outer surface of the third complete concentric optical interference layer providing a fourth interface.

Unless otherwise indicated, the terminology used to describe the embodiments of the invention is to be construed in a manner consistent with the understanding of those skilled in the art. For the sake of clarity, the following terms are to be understood as having the meanings set forth herein:

“Light” refers to electromagnetic radiation having one or more wavelengths in the visible (i.e., from about 380 nm to about 780 nm), ultraviolet (i.e., from about 200 nm to about 380 nm), and/or infrared (i.e., from about 780 nm to about 100 micrometers) regions of the electromagnetic spectrum.

“Refractive index” refers to the index of refraction at a wavelength of 589.3 nm corresponding to the sodium yellow d-line, and a temperature of 20° C., unless otherwise specified. The term “refractive index” and its abbreviation “RI” are used interchangeably herein.

“Retroreflective mode” refers to a particular geometry of illumination and viewing that includes engaging an article with a beam of light and viewing the illuminated article from substantially the same direction, for example within 5 degrees, 4 degrees, 3, degrees, 2 degrees, or 1 degree of the illumination direction. Retroreflective mode can describe the geometry in which a person views an article or the geometry in which an instrument measures the reflectivity of an article.

“Retroreflective brightness” refers to the effectiveness with which an object or ensemble of objects, for example a retroreflective element or an ensemble of elements, or for example an article comprising one or more retroreflective elements, returns incident light back in the direction (or nearly in the direction) from which it came. Retroreflective brightness relates to the intensity of light that is retroreflected from an object, versus the intensity of light that is incident on the object.

“Coefficient of Retroreflection” (Ra) is a standard measure of the retroreflective brightness of an object, and can be expressed in units of candelas per square meter per lux, or Cd/lux/m², or Cpl. These units and measurement instruments that report the coefficient of retroreflection in such units, weight the retroreflective brightness with the luminosity function. The luminosity function describes the dependence of human eye sensitivity on the wavelength of light and is non-zero for wavelengths between approximately 380 nanometers and 780 nanometers, thus defining the visible region of the electromagnetic spectrum.

“Complete concentric optical interference layer” or “optical interference layer” refers to a translucent or transparent coating surrounding and directly adjacent to essentially the entire surface (i.e., not only a selected portion of the surface, for example only the back surface) of a bead core or surrounding and directly adjacent to the outside surface of another, inner complete concentric optical interference layer, the complete concentric optical interference layer being of essentially uniform thickness.

“Reflector” refers to a specular or diffuse reflective material that is placed in a retroreflective article at or near the focal position behind a retroreflective element in a retroreflective article. The reflective material can be a diffuse light-scattering or metallic material, or one or more layers of transparent material components that creates one or more reflective interfaces.

For clarity, in embodiments where more than one reflector is present at or near the focal position behind a spherical bead core in a retroreflective article, the material in contact with or closest to the outer surface of the bead is designated the “primary reflector.”Additional reflectors farther from the back surface of the bead are designated as “auxiliary reflectors”. A stack of directly adjacent dielectric layers is considered to be a single “reflector” for the purpose of designating primary and auxiliary reflectors. For example, an article comprising a bead having two or more complete concentric optical interference layers with back surface embedded in a pigmented binder has complete concentric optical interference layers as a primary reflector and a pigmented binder as an auxiliary reflector.

“Region” refers to a continuous portion of an article. A region typically has a boundary or general extent that is discernible to a viewer.

Those skilled in the art will more fully appreciate the scope of the present invention upon consideration of the remainder of the disclosure including the Detailed Description, the drawings and the appended claims.

### BRIEF DESCRIPTION OF THE DRAWINGS

The various Figures herein are not to scale but are provided as an aid in the description of the embodiments. In describing embodiments of the invention, reference is made to the Figures in which features of the embodiments are indicated with reference numerals, with like reference numerals indicating like features, and wherein:

FIG. 1 is a cross-sectional view of an embodiment of a retroreflective element for use in the articles of the invention;

FIG. 2 is a cross-sectional view of another embodiment of a retroreflective element for use in the articles of the invention;

FIG. 3 is a cross-sectional view of still another embodiment of a retroreflective element for use in the articles of the invention;

FIG. 4 is a flow diagram of an exemplary process for making retroreflective elements useful in the articles of the invention;

FIG. 5 is a cross-sectional view of a pavement marking having a base sheet with protuberances thereon and a plurality of retroreflective elements affixed thereto, according to an embodiment of the invention; and

FIG. 6 is a plan view of the pavement marking of FIG. 5.

### DETAILED DESCRIPTION

Articles of the invention include pavement markings comprising retroreflective elements having one or more complete concentric optical interference layers coated over a solid spherical core. Retroreflective elements comprising one or more complete concentric interference layers provide several advantages over existing pavement markings, including enhanced retroreflected brightness, improved daylight appearance, desired yellow coloration with undoped, unpigmented retroreflective elements, and improved brightness retention. It has been found that the use of retroreflective elements with one or more complete concentric optical interference layers provide a convenient, low cost, effective means of providing reflective pavement markings that demonstrate significantly enhanced retroreflected brightness.

Articles of the present invention comprise pavement markings comprising retroflective elements. In some embodiments, the retroreflective elements described herein may provide retroreflective color in that they display certain colors (e.g., “covert colors”) when viewed in a retroreflective mode. In some embodiments, the retroreflective elements described herein display enhanced retroreflective brightness without producing a change in color.

Retroreflective brightness can be measured for various angles between the incident and reflected light (the observation angle) but is not limited to a particular range of angles. For some applications, effective retroreflectivity is desired at a return angle of zero degrees (anti-parallel to the incident light). For other applications, effective retroreflectivity is desired over a range of return angles such as from 0.1 degree to 1.5 degrees. Where visible light is used to illuminate an object, retroreflective brightness is typically described using the coefficient of retroreflection (Ra).

Retroreflective elements useful in the articles of the present invention each include a solid spherical core with one or more coated layers applied to the core, the one or more coated layers each forming a complete concentric optical interference layer surrounding the core. The first or innermost optical interference layer covers the outer surface of the spherical core. In some embodiments, a second complete concentric optical interference layer covers and is adjacent to the outer surface of the first or innermost complete concentric optical interference layer. In other embodiments, a third complete concentric optical interference layer covers and is adjacent to the outer surface of the second complete concentric optical interference layer. While the complete concentric optical interference layers typically cover the entire surface of the spherical core, optical interference layers may include small pinholes or small chip defects that penetrate the layer without impairing the optical properties of the retroreflective element.

In some embodiments, retroreflective elements may comprise additional complete concentric optical interference layers with each successive optical layer covering a previously deposited layer (e.g., a fourth concentric optical interference layer covers the third concentric optical interference layer; a fifth layer covers the fourth layer, etc.). By “concentric,” what is meant is that each such optical interference layer coated over a given spherical core is a spherically shaped shell that shares its center with the center of the core.

It is within the scope of the present invention to include a variety of retroreflective elements as components of retroreflective articles. Some of the retroreflective elements incorporated into such articles will comprise the retroreflective elements having one or more complete concentric optical interference layers, as described herein. Other retroreflective elements may be included in such articles such as retroreflective elements having no optical interference layers. In some embodiments, articles comprising a mix of retroreflective elements having one or more complete concentric optical interference layers wherein the construction, thickness and/or materials are different from one retroreflective element to another or from one group of retroreflective elements to another group. For example, the first or innermost optical interference layer may vary in thickness from one retroreflective element to another by more than twenty five percent. In some embodiments, the retroreflective elements may include one concentric optical interference layer, in some embodiments two optical interferences layers, in some embodiments three optical interference layers, in some embodiments more than three optical interference layers and in some embodiments combinations of retroreflective elements having one, two, three or more optical interference layers. In some embodiments, the forgoing retroreflective elements may be combined in an article with retroreflective elements having no optical interference layers and/or with auxiliary reflectors and the like.

Complete concentric optical interference layers are applied to a spherical core to provide a retroreflective element capable of providing enhanced retroreflective brightness. When placed in an article, the retroreflective elements provide a retroreflective brightness that is greater than retroreflective brightness of identical articles comprising other forms of retroreflective elements or the like. In some embodiments, the color of the retroreflected light is the same or similar to that of the incident light. For example, the retroreflected light exhibits little or no color change from white incident light. In still other embodiments, the optical interference layers are applied to the core so that, when placed in an article, the retroreflective elements provide a retroreflected color. In some embodiments, the retroreflective elements are arranged in an article to provide a discernable pattern on the surface of the article or substrate wherein the pattern is not visible under diffuse lighting but becomes visible when viewed in the retroreflective mode. In some embodiments, the retroreflective elements may also be used to enhance the color of an article where, for example, the retroreflective elements provide retroreflected color that matches and possibly intensifies the color of the article as it normally appears in diffuse lighting.

When placed within an article, a retroreflective element having a complete concentric optical interference layer on a solid spherical core creates two light-reflective interfaces at the back of a retroreflective element. The thickness of the coating provides an optical thickness that results in a constructive or destructive interference condition for one or more wavelengths that fall within the wavelength range corresponding to visible light (approximately 380 nanometers to approximately 780 nanometers). “Optical thickness” refers to the physical thickness of a coating multiplied by its index of refraction. Such constructive or destructive interference conditions are periodic with increasing optical thickness for the optical interference coating, up to the coherence length of the illumination. With increasing coating thicknesses, constructive interference for a given wavelength will occur first when the optical path through the coating and back again, combined with any phase inversions caused by the sign of refractive index change at either or both interfaces, leads to a phase difference of 2π radians for the two components of light that reflect from the two interfaces. With further increase in thickness, the same constructive interference condition will be achieved again when the phase difference is equal to 4π radians. Similar behavior will occur for further increases in thickness.

The thickness period that separates successive occurrences of the constructive interference condition (that is, the increment in thickness for the coating which leads to repetition of nominally the same interference condition for a given wavelength (in vacuo) of light that is reflected from the two surfaces of the coating) is given by one half of the wavelength in vacuo divided by the index of refraction of the coating. Each occurrence of a given interference condition with increasing coating thickness from zero nanometers can be assigned a period number (e.g., n=1, 2, 3 . . . ). When retroreflective elements comprising an optical interference layer are illuminated with broadband light (light comprising many wavelengths, for example white light), a range of interference effects characterize the retroreflective behavior for the different wavelengths. These optical phenomena become more complex when more than one optical interference layer is applied to the spherical core.

It has been found that the retroreflected color and brightness of retroreflective articles comprising retroreflective elements having one or more complete concentric optical interference layers exhibit periodic behaviors and interdependencies with increasing coating layer thicknesses. Retroreflective elements made with one or more complete concentric optical interference layers, or articles comprising such retroreflective elements, exhibit oscillations of magnitude (e.g., peaks and valleys) in the coefficient of retroreflection (Ra) as one or more of the interference layers increases in thickness. In some embodiments, high coefficient of retroreflection is achieved for white light illumination without the generation of color for the retroreflected light. In other embodiments, high coefficient of retroreflection is generated for white light illumination accompanied by the generation of retroreflected light of color. In some embodiments, the articles can include regions of retroreflective elements that provide any of a variety of displays or designs having a distinctive appearance and/or color under diffuse lighting, as well as a retroreflected color or lack of retroreflected color with a high coefficient of retroreflection under white light illumination when viewed in a retroreflective viewing mode.

The coherence length for non-laser light (for example light produced by an incandescent lamp, a gas discharge lamp, or a light-emitting diode) limits the values of n (and hence the total coating thickness) for which strong interference effects are observed. For non-laser light, interference effects tend to vanish for thicknesses corresponding to n=10 or more, and are greatly diminished at about half of that thickness. For retroreflective elements partially embedded in adhesive with an index of refraction of approximately 1.55, illuminated on their air-exposed side, and comprising a single complete concentric optical interference coating with refractive index of about 2.4, five peaks in photopically weighted retroreflective brightness are established by interference coatings of thicknesses ranging from zero nanometers up to approximately 600 nanometers. These physical thickness values correspond to an optical thickness of up to about 1500 nm. For articles comprising retroreflective elements with a single complete concentric optical interference coating having a refractive index of about 1.4, five peaks in photopically weighted retroreflective brightness are established by interference coatings of thicknesses ranging from zero nanometers up to approximately 1200 nanometers, corresponding to an optical thickness of less than 1700 nm. In some embodiments, a visible light interference layer comprises a coating with an optical thickness less than about 1500 nm.

The retroreflective elements may be included in the construction of any of articles such as the retroreflective pavement markings described herein. Within the construction of such articles, retroreflective elements having one or more complete concentric optical interference layers may be combined with other reflective and/or retroflective materials including for example uncoated retroreflective glass beads having a high index of refraction. Retroreflective articles according to the present invention may optionally include one or more auxiliary reflectors wherein the retroreflective elements and the auxiliary reflector act collectively to return fractions of incident light back in the direction of the source. In some embodiments, a suitable auxiliary reflector is a diffuse light-scattering pigmented binder into which retroreflective elements are partially embedded. A pigmented binder is an auxiliary reflector when the pigment type and loading are selected to create a diffuse-scattering material (for example, greater than 75% diffuse reflection), as opposed to when the selection of pigment and loading are done simply to color a bead binder. Examples of pigments that lead to diffuse scattering include titanium dioxide particles and calcium carbonate particles.

In other embodiments, a suitable auxiliary reflector comprises a specular-pigmented binder into which retroreflective elements are partially embedded. Examples of specular pigments include mica flakes, titanated mica flakes, pearlescent pigments, and nacreous pigments.

In still other embodiments, a suitable auxiliary reflector is a metal thin film that is selectively placed behind the retroreflective element in a retroreflective article.

In still another embodiment, a suitable auxiliary reflector is a dielectric stack of thin films selectively placed behind the retroreflective element in a retroreflective article.

In the case of a retroreflective article (e.g., a pavement marking) wherein the index of refraction of the retroreflective element is between 1.5 and 2.1 and the front surface of the retroreflective element is exposed to air, auxiliary reflectors can be placed adjacent to the back side of the retroreflective elements. In the case of a retroreflective article wherein the retroreflective element is enclosed on its front surface with a transparent material that contacts its front surface or is covered on its front surface by water when in use, auxiliary reflectors may be spaced behind the back surface of the retroreflective elements.

In some embodiments, the present invention provides retroreflective articles for which the need for auxiliary reflectors is optional. Consequently, use of the retroreflective elements having one or more complete concentric optical interference layers can provide enhanced retroreflective brightness as well as reduced manufacturing costs as compared with the cost of manufacturing similar articles that require auxiliary reflectors or alternative primary reflectors. Moreover, the elimination of alternative or auxiliary reflectors can improve the ambient-lit appearance and durability of retroreflective articles made with retroreflective elements having one or more complete concentric optical interference layers.

Retroreflective articles without auxiliary reflectors typically include a plurality of retroreflective elements partially embedded in a transparent (colored or non-colored), non-light-scattering, non-reflective binder (for example a clear, colorless, polymeric binder), and wherein the focal position for light incident on the retroreflective elements is within the binder or at the interface between the retroreflective element and the binder. In some constructions, retroreflective elements include spherical cores in the form of microspheres having an index of refraction of about 1.9. The retroreflective elements are partially embedded in a clear, colorless binder and their front surfaces are exposed to air, providing focal positions near the interface between the back side of the retroreflective elements and the binder. It has been noted that one or more complete concentric optical interference layers can increase the coefficient of retroreflection (Ra).

Articles comprising solid microspheres with an index of refraction of about 1.9 but without concentric optical interference layers, embedded in a clear acrylate adhesive, typically exhibit an Ra of approximately 8 Cd/lux/m² at −4 degrees entrance angle and 0.2 degrees observation angle. The application of a single complete concentric optical interference layer of low index of refraction (for example 1.4) or high index of refraction (e.g., 2.2) to the microspheres increases the Ra to as high as 18 Cd/lux/m² and as high as 30 Cd/lux/m², respectively. The use of two complete concentric optical interference layers over the microsphere core, when placed in an article as described above, provide an increase in the Ra to greater than about 50 Cd/lux/m² and as high as about 59 Cd/lux/m². When articles have been made comprising microspheres having three complete concentric optical interference layers, the Ra has increased to greater than 100 Cd/lux/m² and to as high as 113 Cd/lux/m². Thus, the retroreflective elements of the invention and articles made with such retroreflective elements exhibit useful levels of retroreflection in the absence of auxiliary reflectors.

Referring to the drawings, FIG. 1 illustrates, in cross-section, a first embodiment of a retroreflective element 100 useful in the present invention. The retroreflective element 100 includes a transparent, substantially spherical, solid core 110 having an outer surface 115 that provides a first interface. A first concentric optical interference layer 120 includes an inner surface that overlays the surface 115 of the core 110. Concentric optical interference layer 120 forms a substantially uniform and complete layer over the entire surface 115 of spherical core 110, and the outer surface 125 of layer 120 provides a second interface. Minor imperfections in the layer 120 (e.g., pinholes and/or minor thickness fluctuations) may be tolerated provided such imperfections are not of sufficient size or amount to render the element not retroreflective.

Light is reflected at interfaces between materials having differing refractive indices (e.g., having a difference in refractive indices of at least 0.1). Differences in the refractive indices of the core 110 and the substantially transparent first optical interference layer 120 gives rise to a first reflection at first interface 115. Differences in the refractive indices of the first optical interference layer 120 and any background medium (e.g., vacuum, gas, liquid, solid) contacting first optical interference layer 120 gives rise to a second reflection at second interface 125. Selection of the thickness and the refractive index of the first optical interference layer 120 can result in the two reflections optically interfering with each other to provide a retroreflected color (e.g., a covert color) different from what would otherwise be observed in the absence of such interference. Adjustments to the thickness and refractive index of the first optical interference layer 120 can avoid the destructive interference of the two reflections, providing constructive interference so that a retroreflected light is not of a different color. Moreover, adjusting the thickness of the optical interference layer and the refractive index thereof provides a constructive interference of the reflections from the outer surface 125 of first optical interference layer 120 and surface 115 of solid core 110, resulting in a brighter reflected intensity and enhanced visibility of the article associated with the retroreflective element.

In some embodiments, retroreflected color may be desired to provide retroreflected light in a color that enhances the design and/or the overall visibility of an article that comprises a plurality of retroreflective elements like the element 100.

Incident beam of light, represented by line 130 in FIG. 1, is directed at retroreflective element 100. Light is largely transmitted through first optical interference layer 120, and enters core 110. A portion of the incident light 130 may be reflected at second interface 125 or at first interface 115. Retroreflection may result from the portion of light 130 which enters core 110 and is at least partially focused by refraction onto the back of core 110. As refracted light 135 encounters first interface 115 at the back of core 110, some of refracted light 135 is reflected back as reflected light 140 which ultimately emerges from the retroreflective element 100 as retroreflected light 150, observable in a direction that is substantially anti-parallel to incident light 130. Similarly, another portion of the focused light passes through first optical interference layer 120 and is reflected back at second interface 125 as reflected light 142. The exterior surface 125 of the retroreflective element 100 forms second interface which is directly exposed to the medium in which the retroreflective element 100 is disposed (e.g., gas, liquid, solid, or vacuum). Reflected light 142 emerges from the element as retroreflected light 152, observable in a direction that is substantially anti-parallel to incident light 130. Remaining light that is not reflected passes entirely through the retroreflective element 100. Destructive Interference between reflected light 140 and reflected light 142, and in turn retroreflected light 150 and retroreflected light 152, may give rise to a change in the observed color of the retroreflective element when viewed in a retroreflective mode. For example, destructive interference or subtraction of wavelengths from the center of the spectrum of incident white light results in retroreflected light with a red-violet hue (i.e., retrochromism). Slightly thicker optical interference layers subtract longer wavelengths, resulting in, for example, green or blue-green hues. In some embodiments, the thickness of the optical interference layer is optimized to subtract longer wavelengths and to provide retroreflected light that enhances the color of a substrate or that reveals a desired color (e.g., yellow).

Reflection of light at an interface between materials is dependent on the difference in the refractive indexes of the two materials. Materials for the cores and the optical interference layers may be selected from any of a variety of materials, as described herein. The selected materials may comprise either high or low refractive index materials, as long as sufficient differences in refractive indexes are maintained between that of core 110 and first optical interference layer 120, and between the first optical interference layer 120 and the medium in which the retrochromic element is intended to be used. Each of these differences should be at least about 0.1. In some embodiments, the difference is at least about 0.2. In other embodiments, the difference is at least about 0.3, and in still other embodiments, the difference is at least about 0.5. The refractive index of first optical interference layer 120 may be either greater than or less than the refractive index of core 110. Generally, the choice of refractive index, and the corresponding choice of materials used, will be influenced by the choice of the medium that contacts the exterior surface 125 in the region where reflection is intended to occur.

The refractive indices of core 110, first concentric optical interference layer 120, and the medium in which the retroreflective element 100 is intended to be used are selected to control the focal power of the retroreflective element and the strength of reflections from interfaces 115 and 125.

To obtain a high level of retroreflectivity, the core 110 may be selected to have an index of refraction suitable for use where the entry medium (the medium adjacent the front surfaces of the retroreflective elements) is air. In some embodiments, when the entry medium is air, the index of refraction of the core 110 is between about 1.5 and 2.1. In some embodiments, the index of refraction of the core 110 is between about 1.8 and 1.95. In still other embodiments, the index of refraction of the core 110 is between about 1.9 and 1.94. In some embodiments, the retroreflective elements 100 are used in articles having high retroreflectivity in an exposed-lens construction under wet conditions. In such embodiments, the core 110 may be selected to have an index of refraction typically between about 2.0 and about 2.6. In other embodiments, the index of refraction of the core is between 2.3 and 2.6. In still other embodiments, the index of refraction of the core is between 2.4 and 2.55. Retroreflective elements used in the articles of the invention (e.g., pavement markings) can comprise those suitable for dry conditions along with those suitable for wet conditions. In some embodiments, the binder may include an auxiliary reflector in the form of one or more pigments such as a diffuse-scattering or specular pigment that enhances the retroreflectivity of the article.

Upon selection of a suitable core 110, the core may then be first coated with a material to form first complete concentric optical interference layer 120. In some embodiments, as described herein, first layer 120 is first formed to concentrically coat core 110 and is subsequently further coated with other materials of different refractive indexes to provide second, third, or more complete concentric optical interference layers, as described further herein. Retroreflective element 100 may be used as a component in a reflective article by affixing the retroreflective element to a substrate or backing by, for example, partially embedding the retroreflective element in a polymeric binder or adhesive to provide a beaded substrate which can be affixed to another article or to pavement. In some embodiments, an auxiliary reflector may be included in the construction of the article.

In some embodiments, the solid spherical cores have a diameter within the range from about 25 microns to about 500 microns. In some embodiments, the cores can have a diameter greater than about 500 micrometers. In still other embodiments, the core diameter may be greater than 1 millimeter.

Light that is reflected at an interface may be reflected with or without a phase inversion. Light that passes through a medium having a higher index of refraction and encounters an interface with a medium having a lower index of refraction will be reflected without phase inversion. In contrast, light that passes through a medium having a lower index of refraction and encounters an interface with a medium having a higher index of refraction will be reflected with phase inversion. Consequently, the thickness of the optical interference layer 120 is selected by due consideration of the refractive index of core 110, the refractive index of the first concentric optical interference layer 120, and the refractive index of the medium in which the bead 100 is disposed.

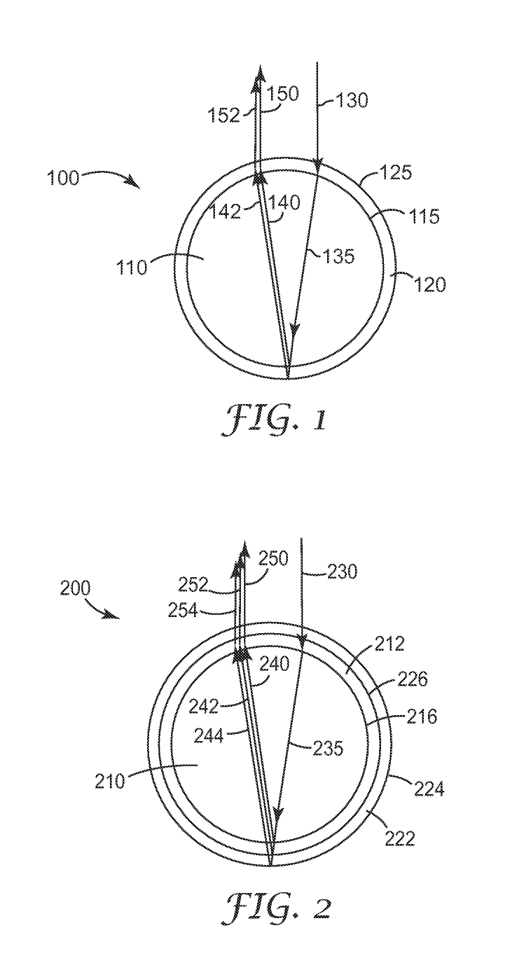

In other embodiments, retroreflective elements comprising more than one complete concentric optical interference layer are provided. Referring to FIG. 2, another embodiment of a retroreflective element 200 is shown and will now be described. The retroreflective element 200 includes a transparent substantially spherical solid core 210 having thereon a first optical interference layer 212. Core 210 contacts first optical interference layer 212 at first interface 216 which coincides with the outer surface of the core 210. Second concentric optical interference layer 222 overlies the first concentric optical interference layer 212 at second interface 226. Layer 222 has an exterior surface 224 that provides the outermost surface of the retroreflective element 200. The first and second optical interference layers 212 and 222 are substantially uniform in thickness and concentric with the spherical core 210.

Light is reflected at the interfaces between the materials used in the retroreflective element 200, provided that the different materials have sufficiently different refractive indexes (e.g., having a difference in refractive indexes of at least about 0.1). A sufficient difference in the refractive indexes of the core 210 and first optical interference layer 212 gives rise to a first reflection at first interface 216. Similarly, a sufficient difference in the refractive indexes of first optical interference layer 212 and second optical interference layer 222 gives rise to a second reflection at second interface 226. A sufficient difference in the refractive indexes of second optical interference layer 222 and any background medium (e.g., vacuum, gas, liquid, solid) contacting the layer 222 gives rise to a third reflection at third interface 224 of the retroreflective element 200. Selection of the thicknesses and refractive indexes of the optical interference layers 212 and 222 provide enhanced retroreflected light.

When a plurality of retroreflective elements 200 are combined in an article, the article displays enhanced retroreflective brightness. In some embodiments, under white light illumination, the retroreflected light may destructively interfere with each other for certain wavelengths, resulting in retroreflected color that is of a different color from that which would otherwise be observed in the absence of such interference.

Referring again to FIG. 2, an incident beam of light is represented by line 230 which is shown as directed at retroreflective element 200. Light 230 is largely transmitted through second optical interference layer 222 and first optical interference layer 212 before it enters core 210. However, portions of the incident light 230 may be reflected at third interface 224, at second interface 226 or at first interface 216. The portion of the light 230 that enters core 210, is focused by refraction onto the opposite side of the core 210. The refracted light 235 encounters first interface 216 at the back of core 210, some of refracted light 235 is reflected back as reflected light 240 towards the front of the retroreflective element 200 where it emerges from the retroreflective element as retroreflected light 250 in a direction that is substantially anti-parallel to incident light 230. Another portion of the focused light passes through optical interference layer 212 and is reflected back at second interface 226 as reflected light 242. Reflected light 242 emerges from the retroreflective element as retroreflected light 252 which travels in a direction that is substantially anti-parallel to incident light 230. Still another portion of the focused light passes through first and second optical interference layers 212 and 222 and is reflected back at third interface 224 as reflected light 244 which emerges from the retroreflective element 200 as retroreflected light 254. The exterior surface of optical interference layer 224 forms a third interface with the medium in which the retroreflective element 200 is disposed (e.g., gas, liquid, solid, or vacuum). A portion of incident light is not reflected but passes entirely through the retroreflective element 200.

Interference between reflected light 240, 242, 244 and in turn retroreflected light 250, 252, 254 may give rise to a change in color of the retroreflected light, with respect to the incident light (for example incident white light). For example, subtraction of wavelengths from the center of the spectrum of incident white light results in retroreflected light with a red-violet hue (i.e., retrochromism). Slightly thicker optical interference layers subtract longer wavelengths, resulting in, for example, green or blue-green hues. When incorporated in an article, a plurality of retroreflective elements 200 can provide retroreflective color that enhance the appearance of the article by providing a desired color or design. A retroreflective color effect can be obtained by manufacturing the retroreflective element 200 with optical interference layers 212 and 222 of different materials and by selecting the thicknesses and refractive indexes of those materials so that the aforementioned retroreflected light 250, 252, 254 destructively interferes with each other. As a result, the retroreflective element 200, when viewed in a retroreflective mode, provides retroreflected light of a different color from that which would otherwise be observed in the absence of destructive interference.

In other embodiments, the proper selection of materials, thicknesses and refractive indexes for the optical interference layers 212, 222, a retroreflective element 200 can provide retroreflected light 250, 252, 254 that is brighter (e.g., has a higher coefficient of retroreflection (Ra)) than retroreflected light from uncoated retroreflective elements, for example. When incorporated in an article, a plurality of retroreflective elements 200 provide retroreflective properties that enhance the visibility of the article. Constructive interference between reflected light 240, 242, 244 and in turn retroreflected light 250, 252, 254 gives rise to unexpected increases in the brightness or intensity of the retroreflected light. In some embodiments, coating thicknesses for the two optical interference layers can be optimized to provide maximum retroreflectivity when the layers are alternating layers of silica/titania and the core comprises a glass bead having a diameter of measuring from about 30 μm to about 90 μm and index of refraction of approximately 1.93. In such embodiments, a first optical interference layer 212 of silica having a thickness between about 95 nm and 120 nm, and typically about 110 nm, a second optical interference layer 222 of titania having a thickness between about 45 nm and 80 nm and typically about 60 nm, has provided significantly enhanced coefficient of retroreflection (Ra) when the retroreflective elements are partially embedded as a monolayer in acrylate adhesive.

Reflection at an interface between materials is dependent on the difference in the refractive indexes of the two materials. Materials for the cores and the optical interference layers may be selected from any of a variety of materials, as described herein. The selected materials may comprise either high or low refractive index materials, as long as a sufficient difference in the refractive indexes is maintained between adjacent materials (e.g., core/layer 212; layer 212/layer 222) and as long as the core provides the desired refraction. The difference in refractive indexes of core 210 and first optical interference layer 212, and the difference in refractive indexes of first optical interference layer 212 and second optical interference layer 222, and the difference between the refractive indexes of second optical interference layer 222 and the medium against which the back side of retroreflective element 200 is intended to be placed should each be at least about 0.1. In some embodiments, each of the differences between the adjacent layers is at least about 0.2. In other embodiments, the differences are at least about 0.3, and in still other embodiments, the differences are at least about 0.5. The refractive index of optical interference layer 212 may be either greater than or less than the refractive index of core 210. In some embodiments, the choice of refractive index, and the corresponding choice of materials used, will be determined by the choice of the medium that contacts the exterior surface of the retroreflective element 200 to form third interface 224 where reflection is intended to occur.

As described above, for completely concentrically coated retroreflective elements with a front surface surrounded by air and a rear surface surrounded by (e.g., embedded in) a medium having a refractive index of about 1.55, such as a polymer binder, and illuminated with white light, the photopically weighted net intensity of reflected light, to the extent that it is determined by the sequence of transmission and reflection events for exactly antiparallel rays of retroreflected light as they enter and leave the retroreflective element, can vary dramatically with coating thickness or thicknesses, for a given desirable set of coating materials and refractive index values. The photopically weighted net intensity of reflected light produced by the three interfaces established by two coating layers (for example, of amorphous silica, followed by amorphous titania, on a 1.93 refractive index bead core) can vary by a factor of at least four. For some choices of coatings and thicknesses, the photopically weighted net intensity of reflected light can be significantly reduced versus a retroreflective element in the form of an uncoated bead.

When a thin single interference layer of a given material is chosen resulting in a certain index difference at each of the two reflecting interfaces (for example, silica on a 1.93 RI bead core), the photopically weighted net intensity of reflected light can vary by a factor of at least about 6 depending on the thickness of the coating. The photopically weighted net intensity of reflected light produced by the three interfaces established by two coating layers (for example, of amorphous silica and titania on a 1.93 refractive index bead core) can vary by a factor of at least 12, depending on the exact thickness of the two concentric coatings.

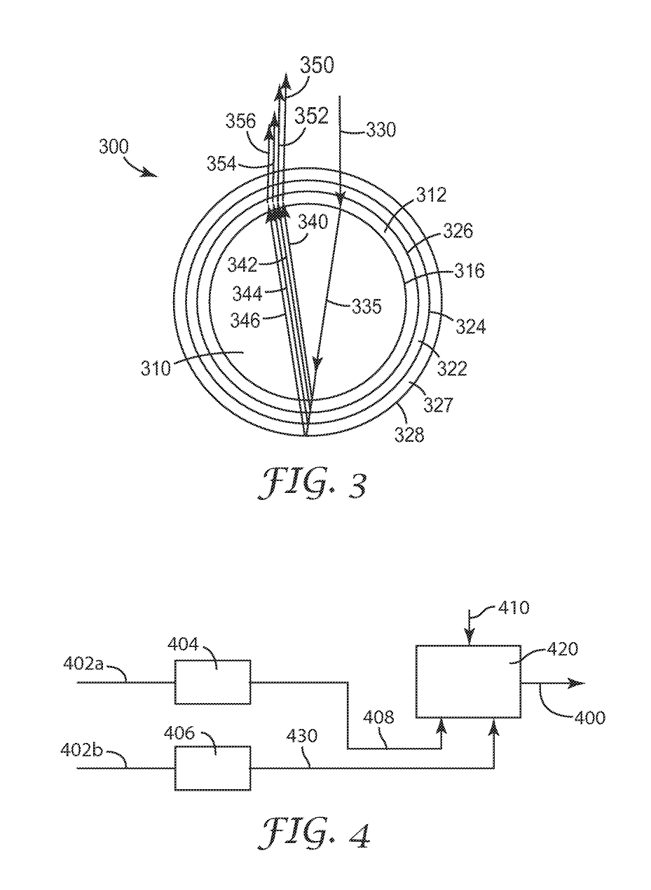

In other embodiments, retroreflective elements comprising more than two optical interference layers may be provided. Referring to FIG. 3, another embodiment of a retroreflective element in the form of a retroreflective element 300 is shown and will now be described. The retroreflective element 300 includes a transparent substantially spherical solid core 310 having thereon a first optical interference layer 312. Core 310 contacts first optical interference layer 312 at first interface 316. Second concentric optical interference layer 322 overlies the first concentric optical interference layer 312. Layer 322 has an interior surface that contacts the exterior or outermost surface 326 of first layer 312, forming a second interface. The retroreflective element 300 includes a third optical interference layer 327 which contacts the outermost surface 324 of the second optical interference layer 322 to provide a third interface. The third optical interference layer 327 includes an exterior surface 328 which forms the outermost surface of the retroreflective element 300 and provides a fourth interface. The first, second and third optical interference layers 312, 322 and 327 are substantially uniform in thickness and concentric with the spherical core 310.

Light is reflected at the interfaces between the materials used in the retroreflective element 300, provided that the different materials have sufficiently different refractive indexes (e.g., having a difference in refractive indexes of at least about 0.1). A sufficient difference in the refractive indexes of the core 310 and first optical interference layer 312 gives rise to a first reflection at first interface 316. Similarly, a sufficient difference in the refractive indexes of first optical interference layer 312 and second optical interference layer 322 gives rise to a second reflection at second interface 326. A sufficient difference in the refractive indexes of second optical interference layer 322 and third optical interference layer 327 gives rise to a third reflection at third interface 324. A sufficient difference in the refractive indexes of third optical interference layer 327 and any background medium (e.g., vacuum, gas, liquid, solid) contacting third optical interference layer 327 gives rise to a fourth reflection at fourth interface 328 of the retroreflective element 300. Selection of the thicknesses and refractive indexes of the optical interference layers 312, 322 and 327 the four reflections provide a retroreflected light that enhances the visibility of an article that includes the retroreflective element 300 as a part thereof. In some embodiments, under white light illumination, the four reflections may destructively interfere with each other for certain wavelengths, resulting in retrochromism wherein the retroreflected light is of a different color from that which would otherwise be observed in the absence of such interference.

Referring again to FIG. 3, an incident beam of light 330 is shown as being directed at retroreflective element 300. Light 330 is shown as being largely transmitted through third optical interference layer 327, second optical interference layer 322 and first optical interference layer 312 before it enters core 310. However, portions of the incident light 330 may be reflected at fourth interface 328, at third interface 324, at second interface 326 or at first interface 316. The portion of the light 330 that enters core 310, is focused by refraction onto the opposite side of the core 310. The refracted light 335 encounters first interface 316 at the back of core 310, some of refracted light 335 is reflected back as reflected light 340 towards the front of the retroreflective element 300 where it emerges from the retroreflective element as retroreflected light 350 in a direction that is substantially anti-parallel to incident light 330. Another portion of the focused light passes through optical interference layer 312 and is reflected back at second interface 326 as reflected light 342. Reflected light 342 emerges from the retroreflective element as retroreflected light 352 which travels in a direction that is substantially anti-parallel to incident light 330. Still another portion of the focused light passes through first and second optical interference layers 312 and 322 and is reflected back at third interface 324 as reflected light 344 which emerges from the retroreflective element 300 as retroreflected light 354. Still another portion of the focused light passes through first, second and third optical interference layers 312, 322 and 327 and is reflected back at fourth interface 328 as reflected light 346 which emerges from the retroreflective element 300 as retroreflected light 356. The exterior surface of optical interference layer 327 forms a fourth interface 328 with the medium in which the retroreflective element 300 is disposed (e.g., gas, liquid, solid, or vacuum). A portion of incident light is not reflected but passes entirely through the retroreflective element 300.

Interference between reflected light 340, 342, 344, 346 and in turn retroreflected light 350, 352, 354, 356 may give rise to a change in color of the retroreflected light, with respect to the incident light (for example incident white light). For example, subtraction of wavelengths from the center of the spectrum of incident white light results in retroreflected light with a red-violet hue (i.e., retrochromism). Slightly thicker optical interference layers subtract longer wavelengths, resulting in, for example, green or blue-green hues. When incorporated in an article, a plurality of retroreflective elements 300 can provide retrochromic properties that enhance the appearance of the article by providing a covert color, design, message or the like. A retrochromic effect can be obtained by manufacturing the retroreflective element 300 with optical interference layers 312, 322 and 327 of different materials and by selecting the thicknesses and refractive indexes of those materials so that the aforementioned retroreflected light 350, 352, 354, 356 destructively interfere with each other. As a result, the retroreflective element 300, when viewed in a retroreflective mode, provides retroreflected light of a different color from that which would otherwise be observed in the absence of destructive interference.

In other embodiments, the proper selection of materials, thicknesses and refractive indexes for the optical interference layers 312, 322, 327, retroreflective element 300 can provide retroreflected light 350, 352, 354, 356 that is brighter (e.g., has a higher coefficient of retroreflection (Ra)) than retroreflected light from uncoated retroreflective elements, for example. When incorporated in an article, a plurality of retroreflective elements 300 provide retroreflective properties that enhance the visibility of the article. Constructive interference between reflected light 340, 342, 344, 346 and in turn retroreflected light 350, 352, 354, 356 gives rise to unexpected increases in the brightness or intensity of the retroreflected light. In some embodiments, coating thicknesses for the three optical interference layers can be optimized to provide maximum retroreflectivity when the layers are alternating layers of silica/titania/silica and the core comprises a solid glass bead having a diameter of measuring from about 30 μm to about 90 μm and index of refraction of approximately 1.93. In such embodiments, a first optical interference layer 312 of silica having a thickness between about 95 nm and 120 nm, and typically about 110 nm, a second optical interference layer 322 of titania having a thickness between about 45 nm and 80 nm and typically about 60 nm, and a third optical interference layer 327 of silica having a thickness between about 70 nm and 115 nm, and typically about 100 nm, has provided significantly enhanced coefficient of retroreflection (Ra) when the retroreflective elements are partially embedded as a monolayer in acrylate adhesive.

Reflection at an interface between materials is dependent on the difference in the refractive indexes of the two materials. Materials for the cores and the optical interference layers may be selected from any of a variety of materials, as described herein. The selected materials may comprise either high or low refractive index materials, as long as a sufficient difference in the refractive indexes is maintained between adjacent materials (e.g., core 310/layer 312; layer 312/layer 322; layer 322/layer 327) and as long as the core provides the desired refraction. The difference in refractive indexes of core 310 and first optical interference layer 312, and the difference in refractive indexes of first optical interference layer 312 and second optical interference layer 322, and the difference between the refractive indexes of second optical interference layer 322 and third optical interference layer 327, and the difference between the refractive indexes of third optical interference layer 327 and the medium against which the back side of retroreflective element 300 is intended to be placed should each be at least about 0.1. In some embodiments, each of the differences between the adjacent layers is at least about 0.2. In other embodiments, the differences are at least about 0.3, and in still other embodiments, the differences are at least about 0.5. The refractive index of optical interference layer 312 may be either greater than or less than the refractive index of core 310. In some embodiments, the choice of refractive index, and the corresponding choice of materials used, will be determined by the choice of the medium that contacts the exterior surface of the retroreflective element 300 to form third interface 324 where reflection is intended to occur.

As described above, for completely concentrically coated retroreflective elements with a front surface surrounded by air and a rear surface surrounded by (e.g., embedded in) a medium having a refractive index of about 1.55, such as a polymer binder, and illuminated with white light, the photopically weighted net intensity of reflected light, to the extent that it is determined by the sequence of transmission and reflection events for exactly antiparallel rays of retroreflected light as they enter and leave the retroreflective element, can vary dramatically with coating thickness or thicknesses, for a given desirable set of coating materials and refractive index values. The photopically weighted net intensity of reflected light produced by the four interfaces established by three coating layers (for example, of amorphous silica, followed by amorphous titania, followed by amorphous silica, on a 1.93 refractive index bead core) can vary by a factor of at least four. For some choices of coatings and thicknesses, the photopically weighted net intensity of reflected light can be significantly reduced versus a retroreflective element in the form of an uncoated bead.

Suitable materials to use as coatings for the foregoing optical interference layers include inorganic materials that provide transparent coatings. Such coatings tend to make bright, highly retroreflective articles. Included within the foregoing inorganic materials are inorganic oxides such as TiO₂ (refractive index of 2.2-2.7) and SiO₂ (refractive index of 1.4-1.5) and inorganic sulfides such as ZnS (refractive index of 2.2). The foregoing materials can be applied using any of a variety of techniques. Other suitable materials having a relatively high refractive index include CdS, CeO₂, ZrO₂, Bi₂O₃, ZnSe, WO₃, PbO, ZnO, Ta₂O₅, and others known to those skilled in the art. Other low refractive index materials suitable for use in the present invention include Al₂O₃, B₂O₃, AlF₃, MgO, CaF₂, CeF₃, LiF, MgF₂ and Na₃AlF₆.

Where the coated retroreflective elements of the invention are to be used in an environment where water insolubility is not needed, other materials may be used such as, for example, sodium chloride (NaCl). Additionally, it is within the scope of the invention to concentrically coat the bead cores with multiple layers wherein at least one of the layers is an organic coating. In some embodiments, the use of one or more organic coatings is preferred when the organic coating, and other coatings supported on it, are to be preferentially removed from the front surface of the coated retroreflective elements. The selective removal of front surface coatings might be desired to provide a coating design with high reflectivity for its collection of interfaces when intact and adjacent to a background polymeric binder, but to lower reflectivity for the front-face when the those front-face coatings were removed.

In the use of some embodiments, portions of one or more of the optical interference layers can be removed to expose underlying optical interference layer(s) or to expose at least a portion of the core. Removal of portions of one or more optical interference layer(s) can occur during the initial manufacture of the retroreflective elements, prior to release of a product into the field or at a later time after product comprising the retroreflective elements has already been released and applied in an end use (e.g., removal by wear).

In some embodiments, the retroreflective elements 300 are used in articles having high retroreflectivity in an exposed-lens construction under dry conditions. In such embodiments, the solid spherical core 310 of the retroreflective element 300 has an index of refraction typically between about 1.5 and about 2.1. Typically, when the entry medium is air, the index of refraction of the core 310 is between about 1.5 and 2.1. In other embodiments, the index of refraction of the core 310 is between about 1.7 and about 2.0. In other embodiments, the index of refraction of the core 310 is between 1.8 and 1.95. In other embodiments, the index of refraction of the core 310 is between 1.9 and 1.94.

In order to obtain a desired level of retroreflectivity, the solid spherical core 310 may be selected to have a relatively high index of refraction. In some embodiments, the index of refraction of the core is greater than about 1.5. In other embodiments, the index of refraction of the core is between about 1.55 and about 2.0. In some embodiments, the core 310 may be first coated with low refractive index material (e.g., 1.4-1.7) to form first optical interference layer 312, followed by coating with a high refractive index material (e.g., 2.0-2.6) to form the second optical interference layer 322. Thereafter, the third optical interference layer 327 may be coated over the second optical interference layer using a low refractive index material (e.g., 1.4-1.7). The retroreflective element 300 may be used as a component in a reflective article by affixing the retroreflective element to a substrate or backing. In such a construction, third optical interference layer 327 is affixed to the substrate by, for example, a polymeric adhesive or binder. In some embodiments of the aforementioned articles, an auxiliary reflector may be provided by, for example, use of a pigmented binder that includes diffuse-scattering or specular pigment to enhance the reflective properties and the retroreflectivity of the article.

In other embodiments, the solid spherical core 310 is selected to have a relatively high index of refraction (e.g., greater than about 1.5). In such embodiments, the solid core 310 is first coated with high refractive index material (e.g., 2.0-2.6) to form the first optical interference layer 312, and is then coated with a low refractive index material (e.g., 1.4-1.7) to provide a second optical interference layer 322. Thereafter, the third optical interference layer 327 may be coated over the second optical interference layer using a high refractive index material (e.g., 2.0-2.6). The resulting retroreflective element 300 may be used as a component of a reflective article with the retroreflective element 300 affixed to a substrate or backing. In such a construction, the retroreflective element is affixed to the substrate with third optical interference layer 327 embedded, for example, in a polymeric binder. In some embodiments, the binder itself may be pigmented with diffuse-scattering or specular pigment that enhances the retroreflectivity of the article.

### Manufacture of Retroreflective Elements

Retroreflective elements may be conveniently and economically prepared using a fluidized bed of transparent beads and vapor deposition techniques. In general, the processes of depositing vapor phase materials onto a fluidized (i.e., agitated) bed of a plurality of beads, as used herein, can be collectively referred to as “vapor deposition processes” in which a concentric layer is deposited on the surface of respective transparent beads from a vapor form. In some embodiments, vapor phase precursor materials are mixed in proximity to the transparent beads and chemically react in situ to deposit a layer of material on the respective surfaces of the transparent beads. In other embodiments, material is presented in vapor form and deposits as a layer on the respective surfaces of the transparent beads with essentially no chemical reaction.

Depending upon the deposition process being used, precursor material(s) (in the case of a reaction-based deposition process) or layer material(s) (in the case of a non-reaction-based process), typically in vapor phase, is or are placed in a reactor with transparent beads. The present invention desirably utilizes a vapor phase hydrolysis reaction to deposit a concentric optical interference layer (e.g., a layer of metal oxide) onto the surface of a respective core. Such process is sometimes referred to as a chemical vapor deposition (“CVD”) reaction.

Desirably, a low temperature, atmospheric pressure chemical vapor deposition (“APCVD”) process is used. Such processes do not require vacuum systems and can provide high coating rates. Hydrolysis-based APCVD (i.e., APCVD wherein water reacts with a reactive precursor) is most desired because of the ability to obtain highly uniform layers at low temperatures, e.g., typically well below 300° C.

The following is an illustrative vapor phase hydrolysis-based reaction:

TiCl₄+2H₂O→TiO₂+4HCl

In the illustrative reaction, water vapor and titanium tetrachloride, taken together, are considered metal oxide precursor materials.

Useful fluidized bed vapor deposition techniques are described, for example, in U.S. Pat. No. 5,673,148 (Morris et al.), the disclosure of which is incorporated herein by reference.

A well-fluidized bed can ensure that uniform layers are formed both for a given particle and for the entire population of particles. In order to form substantially continuous layers covering essentially the entire surfaces of the transparent beads, the transparent beads are suspended in a fluidized bed reactor. Fluidizing typically tends to effectively prevent agglomeration of the transparent beads, achieve uniform mixing of the transparent beads and reaction precursor materials, and provide more uniform reaction conditions, thereby resulting in highly uniform concentric optical interference layers. By agitating the transparent beads, essentially the entire surface of each assembly is exposed during the deposition, and the assembly and reaction precursors or layer material may be well intermixed, so that substantially uniform and complete coating of each bead is achieved.

If using transparent beads that tend to agglomerate, it is desirable to coat the transparent beads with fluidizing aids, e.g., small amounts of fumed silica, precipitated silica, methacrylato chromic chloride having the trade designation “VOLAN” (available from Zaclon, Inc., Cleveland, Ohio). Selection of such aids and of useful amounts thereof may be readily determined by those with ordinary skill in the art.

One technique for getting precursor materials into the vapor phase and adding them to the reactor is to bubble a stream of gas, desirably a non-reactive gas, referred to herein as a carrier gas, through a solution or neat liquid of the precursor material and then into the reactor. Exemplary carrier gases include argon, nitrogen, oxygen, and/or dry air.

Optimum flow rates of carrier gas(es) for a particular application typically depend, at least in part, upon the temperature within the reactor, the temperature of the precursor streams, the degree of assembly agitation within the reactor, and the particular precursors being used, but useful flow rates may be readily determined by routine optimization techniques. Desirably, the flow rate of carrier gas used to transport the precursor materials to the reactor is sufficient to both agitate the transparent beads and transport optimal quantities of precursor materials to the reactor.

Referring to FIG. 4, an exemplary process for the manufacture of retroreflective elements is schematically shown. A carrier gas is fed through line 402a, and the gas is bubbled through water bubbler 404, to produce water vapor-containing precursor stream which is directed through steam line 408. A second stream of carrier gas is fed through line 402b and is bubbled through titanium tetrachloride bubbler 406, to produce titanium tetrachloride-containing precursor stream which is directed through line 430. Precursor streams within lines 408 and 430 are transported into reactor 420. Cores are introduced into reactor 420 through inlet 410, and outlet 400 is provided for the removal of retroreflective elements 400 from the reactor 420.

Precursor flow rates are adjusted to provide an adequate deposition rate onto the uncoated beads and to provide a metal oxide layer of a desired quality and character. Desirably, flow rates are adjusted such that the ratios of precursor materials present in the reactor chamber promote metal oxide deposition at the surface of the transparent beads with minimal formation of discrete, i.e., free floating, metal oxide particles, elsewhere in the chamber. For example, if depositing layers of titania from titanium tetrachloride and water, a ratio of between about eight water molecules per each titanium tetrachloride molecule to one water molecule per two titanium tetrachloride molecule is generally suitable, with about two water molecules of water per titanium tetrachloride molecule being preferred. Under these conditions there is sufficient water to react with most of the titanium tetrachloride and most of the water is adsorbed onto the surface of the retroreflective element. Much higher ratios tend to yield substantial quantities of unadsorbed water that might result in formation of oxide particulates rather than the desired oxide layers.

In some embodiments, precursor materials have sufficiently high vapor pressures that sufficient quantities of precursor material will be transported to the reactor for both the hydrolysis reaction and the layer deposition process to proceed at a convenient rate. For instance, precursor materials having relatively higher vapor pressures typically provide faster deposition rates than precursor materials having relatively lower vapor pressures, thereby enabling the use of shorter deposition times. Precursor sources may be cooled to reduce vapor pressure or heated to increase vapor pressure of the material. The latter may necessitate heating of tubing or other means used to transport the precursor material to the reactor, to prevent condensation between the source and the reactor. In many instances, precursor materials will be in the form of neat liquids at room temperature. In some instances, precursor materials may be available as sublimable solids.

In some embodiments, the coating of glass beads utilizes precursor materials capable of forming dense metal oxide coatings via hydrolysis reactions at temperatures below about 300° C., and typically below about 200° C. In some embodiments, titanium tetrachloride and/or silicon tetrachloride, and water are used as precursor materials. In addition to water and volatile metal chlorides, some embodiments of the invention utilize other precursor materials such as, for example, at least one of: metal alkoxide(s) (e.g., titanium isopropoxide, silicon ethoxide, zirconium n-propoxide), metal alkyl(s) (e.g., trimethylaluminum, diethylzinc). It may be desirable to utilize several precursors simultaneously in a coating process.

Desirably, mutually reactive precursor materials, e.g., TiCl₄ and H₂O, are not mixed prior to being added to the reactor in order to prevent premature reaction within the transport system. Accordingly, multiple gas streams into the reaction chamber can be provided.

Vapor deposition processes include hydrolysis based CVD and/or other processes. In such processes, the beads are typically maintained at a temperature suitable to promote effective deposition and formation of the concentric optical interference layer with desired properties on the beads. Increasing the temperature at which the vapor deposition process is conducted typically yields a resultant concentric layer that is denser and retains fewer fugitive unreacted precursors. Sputtering or plasma-assisted chemical vapor deposition processes, if utilized, often require minimal heating of the article being coated, but typically require vacuum systems, and can be difficult to use if coating particulate materials such as small glass beads.

Typically, a deposition process that operates at a temperature low enough not to undesirably degrade the transparent beads should be selected. Thus, deposition of the optical interference layer is desirably achieved using a hydrolysis-based APCVD process at temperatures below about 300° C., more typically below about 200° C.

Titania and titania-silica layers deposited from tetrachlorides are particularly desired, and are easily deposited by APCVD at low temperatures, e.g., between about 120° C. and about 160° C.

Any dimensionally stable, substantially spherical, transparent bead may be used as a core for the concentrically coated retroreflective elements used in the present invention. Cores may be inorganic, polymeric or other provided that they are substantially transparent to one or more wavelengths, typically all wavelengths, of visible light. In some embodiments, cores have a diameter from about 20 to about 500 micrometers. In other embodiments, cores have a diameter from about 50 to about 100 micrometers. Other diameters may also be used.

Cores suitable for use in the invention comprise a material, desirably an inorganic glass comprising silica, having a refractive index from about 1.5 to about 2.5 or higher. In some embodiments, the cores have a refractive index from about 1.7 to about 1.9. Cores may also have a lower refractive index value depending on the particular intended application, and the composition of the concentric optical interference layer. For example, a silica glass retroreflective element with refractive index as low as about 1.50 may be desirably used as a core because of the low cost and high availability of soda-lime-silica (i.e., window glass). Optionally, cores may further comprise a colorant.

Exemplary materials that may be utilized as a core include any of a variety of glasses (e.g., mixtures of metal oxides such as SiO₂, B₂O₃, TiO₂, ZrO₂, Al₂O₃, BaO, SrO, CaO, MgO, K₂O, Na₂O). In other embodiments, the cores may comprise solid, transparent, non-vitreous, ceramic particles such as those as described in, for example, U.S. Pat. Nos. 4,564,556 (Lange) and 4,758,469 (Lange), the disclosures of which are incorporated in their entireties herein by reference thereto. Commercially available glass retroreflective elements suitable for use as cores herein include those available from Flex-O-Lite, Inc. of Chesterfield, Mo.

Exemplary useful colorants include transition metals, dyes, and/or pigments, and are typically selected according to compatibility with the chemical composition of the core, and the processing conditions utilized.

The concentric optical interference layer employed in practice according to the present invention may be of any transparent material having a different refractive index than the core supporting the layer. In some embodiments, the concentric optical interference layer(s) should be sufficiently smooth so as to be optically clear while also being tough in that the optical interference layer(s) is not easily chipped or flaked.

In embodiments, the concentric optical interference layer(s) comprise metal oxide. Exemplary metal oxides useful for the concentric optical interference layer include titania, alumina, silica, tin oxide, zirconia, antimony oxide, and mixed oxides thereof. Desirably, the optical interference layer comprises one of the following: titanium dioxide, silicon dioxide, aluminum oxide, or a combination thereof. In some embodiments, titania and titania/silica layers are used because they are readily deposited to form durable layers.

Portions of retroreflective elements having various optical interference layer thicknesses and retroreflective colors can be removed from a reactor sequentially. One, two, three, or more pluralities of retroreflective elements, each plurality having a different retroreflective color and collectively comprising a retrochromic color palette, may thus be easily obtained by charging a reactor with a large quantity of beads and sequentially removing portions of retroreflective elements during a continuing coating run.

In one embodiment, the progress of layer deposition may be monitored by viewing the beads in retroreflective mode, for example, by using a retroviewer (e.g., as described in U.S. Pat. Nos. 3,767,291 (Johnson) and 3,832,038 (Johnson), the disclosures of which are incorporated herein by reference) either in situ using a glass-walled reactor or by removal from the reactor. Retroviewers useful for viewing intrinsically retrochromic beads and articles containing them are also readily commercially available, for example, under the trade designation “3M VIEWER” from 3M Company, St. Paul, Minn.

### Pavement Markings

The foregoing retroreflective elements are included in the construction of retroreflective pavement markings to enhance the visibility of the pavement markings, especially at night or in conditions that otherwise effect visibility. In such articles, the retroreflective elements are exposed lens elements, are typically spherically shaped, and are partially embedded in a bonding material, or binder. In a pavement marking, the retroreflective elements can be embedded within a binder to a depth from about 10% to about 90% of the diameter of the retroreflective elements so that a portion of the elements remain ‘exposed’ in that about 10% to about 90% of the diameter of each retroreflective element extends above the outer surface of the binder. Protective coatings (e.g., water repellent or water proof coatings) may optionally be applied over the exposed surfaces of the embedded retroreflective elements, coating such as those described in U.S. Pat. No. 7,247,386, the disclosure of which is incorporated herein by reference thereto.

A suitable binder for retaining the retroreflective elements may comprise a polymeric matrix with or without optional filler particles. Useful filler particles include reflective materials, as previously described, such as inorganic filler particles such as titanium dioxide, talc, calcium carbonate and combinations of the foregoing. Other useful filler particles include nacreous, pearlescent, and specular pigments such as titanated mica particles. Filler particles may be desired with binders for pavement marking serve to scatter incident light such as, for example, light from automobile headlights that is focused by the retroreflective elements into the binder. Retroreflection follows when the scattered light is partially collimated by refraction as it leaves the retroreflective element, causing it to be returned in directions nearly or exactly antiparallel to the incident light direction. Retroreflective elements having one or more complete concentric optical interference layers are observed to increase the fraction of incident light that is returned through retroreflection.

Pavement markings according to the present invention may be made from a coatable liquid binder precursor having the aforementioned retroreflective elements embedded therein. The coatable liquid binder precursor may be applied to the surface of a roadway and thereafter solidified or cured to provide a coating of cured material with retroreflective elements having one or more complete concentric optical interference layers embedded in the binder material. The coatable liquid binder precursor may be a paint like composition similar to those described in U.S. Pat. No. 3,645,933; or U.S. Pat. No. 6,132,132; or U.S. Pat. No. 6,376,574. Other binder materials may be suitable for use in the construction of pavement markings according to the present invention such as thermoplastics such as those described in U.S. Pat. No. 3,036,928; U.S. Pat. No. 3,523,029; and U.S. Pat. No. 3,499,857; two-part reactive binders including epoxies like those described in U.S. Pat. No. 3,046,851 and U.S. Pat. No. 4,721,743; and polyureas like those described in U.S. Pat. No. 6,166,106. In the foregoing embodiments, a plurality of retroreflective elements having one or more concentric optical interference layer may be added to the binder materials prior to their application to a traffic surface such as a roadway, or the retroreflective elements may be applied to the binder material after the binder has been applied to the roadway and prior to hardening, drying or curing thereof. Additional components may be included in the forgoing formulations including the aforementioned fillers, pigments (e.g., specular pigments) and reflective metal flakes as well as dyes, colorants, fibrous materials, nonwoven materials, woven materials and the like.

In some embodiments, pavement markings according to the invention may take the form of a preformed article, sheet, or tape, comprising retroreflective elements disposed on a major surface of a backing or substrate so that the article, sheet or tape can be adhered to a traffic surface such as a roadway or the like. In some embodiments, an adhesive is disposed on the major surface of the substrate opposite the side on which the retroreflective elements are disposed. In some embodiments, adhesive may be first applied to the traffic surface and the article, sheet or tape can be applied over the adhesive to provide the retroreflective article. As mentioned, the retroreflective articles may include a protective layer coated over the retroreflective elements. Representative sheet or tape constructions in which the retroreflective elements are useful are described in, for example, U.S. Pat. No. 4,248,932 (Tung et al.), U.S. Pat. No. 4,988,555 (Hedblom); U.S. Pat. No. 5,227,221 (Hedblom); U.S. Pat. No. 5,777,791 (Hedblom); and U.S. Pat. No. 6,365,262 (Hedblom). Pavement markings may comprise a relatively flat or featureless profile or they may comprise a profile having one or more features to provide a unique, distinctive and functional profile.

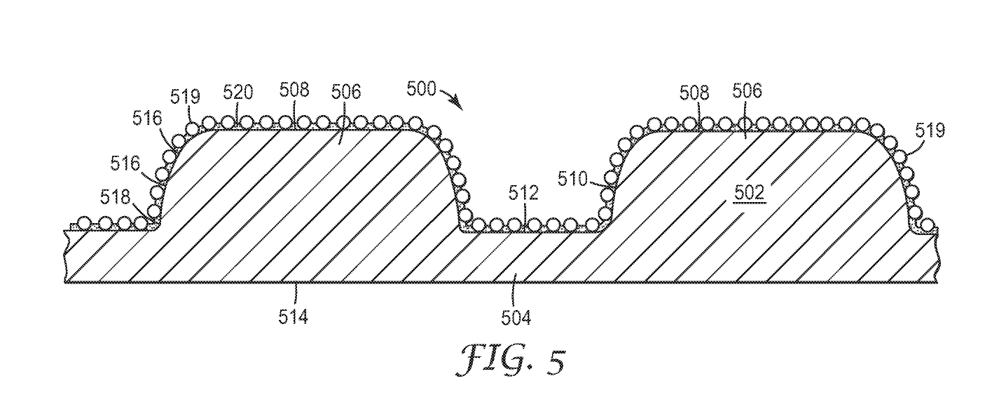

Referring to FIG. 5, one embodiment of a pavement marking 500 according to the invention is shown and will be described. A cross-sectional portion of the pavement marking 500 is depicted and includes a resilient polymeric sheet 502, including a base 504 and a plurality of protrusions 506. The protrusions 506 may be an integral part of the sheet 502, as shown, and include top surfaces 508 and side surfaces 510. In some embodiments, protrusions 506 may have a height of approximately 1.0 mm to 1.5 mm, in some embodiments approximately 1.1 mm. The base 504 has a front surface 512, from which the protrusions 506 extend, and a bottom surface 514 with a thickness in some embodiments measuring about 0.64 mm. The side surfaces 510 meet the top surface 508 at a rounded top portion 516. The side surfaces 510 meet the front surface 512 at a lower portion 518. The side surfaces 510 may form an angle with respect to the base 504 of approximately 70°-72° as measured at the intersection of front surface 512 with the lower portion 518 of the side surface 510.

A plurality of retroreflective elements 519 are disposed along the surfaces 508, 510 and 512 of the pavement marking 500, and at least a portion of retroreflective elements 319 comprise retroreflective elements having one or more complete concentric optical interference layers, as described herein. Retroreflective elements 519 form an integral part of the pavement marking 500, providing retroreflective surfaces along front surface 512, the top surfaces 508 and side surfaces 510 of the protrusions 506. Back surface 514 may be affixed to a surface such as a roadway or the like. Adhesive may be provided on the bottom surface 514, and a scrim layer (woven or nonwoven) may be included if desired.

Retroreflective elements 519 are affixed to the surface of pavement marking 500 with a binder 520 so that a portion of each retroreflective element 519 is embedded in binder 520 while a portion of each retroreflective element 519 extends above the outermost surface of the binder. Useful binders may be selected from any of a variety of binders such as thermosetting binders, thermoplastic binders, pressure-sensitive adhesives, and the like, as mentioned elsewhere herein. Some exemplary binders include without limitation aliphatic or aromatic polyurethanes, polyesters, vinyl acetate polymers, polyvinyl chloride, acrylate polymers, and combinations thereof. The selection of suitable binders is within the skill of those practicing in the field. In some embodiments, the retroreflective elements 519 may be embedded directly in the surface of the protrusions 506, and the layer of binder 520 may be absent. Antiskid particles may also be deposited on the surfaces of the marker 500 to increase skid resistance.

Pavement markings like the pavement marking 500 comprising retroreflective elements having one or more complete concentric optical interference layers exhibit retroreflectivity greater than similar articles comprising other retroreflective elements. In the case of yellow pavement marking stripes for example, retroreflective elements having one or more complete concentric optical interference layers can be designed to enhance the yellow color of the retroreflected light and increase the retroreflectivity relative to pavement markings with beads or cores that do not include the concentric optical interference layer.

In some embodiments, all of the retroreflective elements 519 of the pavement marking 500 of FIG. 5 comprise retroreflective elements having one or more complete concentric optical interference layers, as described herein. In other embodiments, only a portion of the retroreflective elements 519 will have one or more complete concentric optical interference layers. In some embodiments, a portion of the retroreflective elements 519 may comprise retroreflective elements having one or more complete concentric optical interference layers and another portion of the retroreflective elements 519 will comprise spherical cores with no optical interference layers. In still other embodiments, a portion of retroreflective elements 519 will each comprise one complete concentric optical interference layer while another portion will comprise two complete concentric optical interference layers and/or three optical interference layers. Other embodiments may comprise retroreflective elements 519 having only two complete concentric optical interference layers. Still other embodiments of pavement marking 500 may comprise retroreflective elements having only three complete concentric optical interference layers. As those skilled in the art will appreciate, pavement markings of the invention are not limited to one from of retroreflective element so long as the pavement marking includes retroreflective elements wherein at least a portion of such elements include one or more complete concentric optical interference layers. In some embodiments, the retroreflective articles of the invention, such as article 500, can include combinations of retroreflective elements that include those best suited for retroreflection under dry conditions (refractive index from 1.5 to 2.1) and those that exhibit retroreflection under wet conditions (e.g., refractive index from 2.0 to 2.6) such as when the article is exposed to rain or snow.

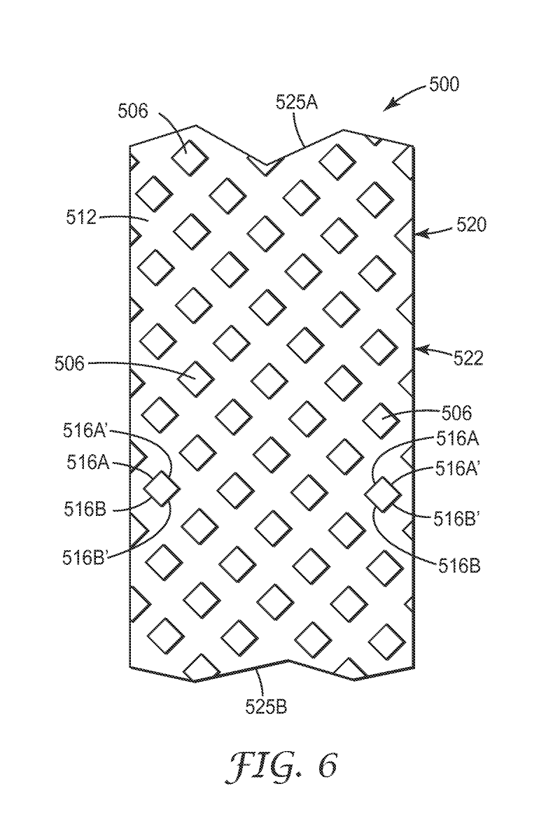

Referring to FIG. 6, a top plan view of the pavement marking 500 is shown with a plurality of protrusions 506 disposed on base 504 with the protrusions arranged in rows and columns oriented at about a 45° angle with respect to edge 524 of the pavement marking 500. Article 500 is shown with an “upweb” direction represented by reference numeral 525A and a “downweb” direction represented by reference numeral 525B. “Upweb” refers to the general direction of web portions to which bead bond has not yet been applied, and “downweb” refers to the direction of web portions to which bead bond has previously been applied. Protrusions 506 have a generally square outline such that each of the protrusions 506 has four side surfaces (e.g., surface 510 in FIG. 5), each side having a sloping top portion 516. Two of the top portions 516A on each protrusion 506 are oriented to face the upweb direction 525A and two top portions 516B are oriented to face the downweb direction 525B. In some embodiments, the length of the portions 516 is typically between about 2 mm and about 10 mm, in some embodiments between about 4 mm and about 8 mm, in some embodiments between about 5 mm and about 7 mm.

The use of retroreflective elements having one of more complete concentric interference layers providing high front and rear surface reflectivity can result in improved brightness retention behavior. When a pavement marking containing such retroreflective elements is subject to wear, such as due to tire contact, the loss of one or more of the concentric optical interference layers on the exposed surfaces of the retroreflective elements could result in enhanced retroreflective brightness. The increased retroreflectivity from such retroreflective elements could provide at least partial compensation for a loss in brightness due bead loss, soiling, and the like.

Beads comprising one or more complete concentric optical interference layers can be either retrochromic or nonretrochomic and still provide pavement markings having significantly enhanced retroreflected brightness. Hence, bright markings having essentially white retroreflection, or bright markings having, for example, yellow retroreflection can be produced without doping or pigmenting of the retroreflective elements as is conventionally used to produce yellow retroreflected light.

Retroreflective elements comprising one or more complete concentric optical interference layers can be used to produce pavement markings with improved daylight appearance. For example, micaceous pigments can produce retroreflected brightness greater than the retroreflected brightness of white titania pigments. However, pavement markings comprising the micaceous pigments can be more expensive, and exhibit a dull or discolored appearance in daylight. Pavement markings of the invention include embodiments comprising coated beads and titania pigments resulting in retroreflected brightness at least equal to similar constructions having micaceous pigments, and exhibiting clean white daylight appearance characteristic of titanated articles and superior to articles with micaceous pigments.

The following non-limiting examples illustrate specific embodiments of the present invention.

### EXAMPLES

The following standard procedures were employed.

### Procedure A: Preparation of Retroreflective Elements

Retroreflective elements with complete concentric optical interference layers were formed by depositing metal oxide (titania or silica) coatings onto transparent bead cores using an atmospheric pressure chemical vapor deposition process (APCVD) similar to that described in U.S. Pat. No. 5,673,148 (Morris et al.), the disclosure of which is incorporated herein by reference thereto. The reactor had an internal diameter of 30 mm. The initial charge of transparent bead cores weighed 60g. For silica coatings, the reaction temperature was set at 40° C. while titania coatings were deposited using a reaction temperature of 140° C. The desired reaction temperature was controlled by immersing the reactor in a heated oil bath maintained at a constant temperature. The bed of beads was fluidized with a stream of nitrogen gas introduced into the reactor through a glass frit reactor base. Once satisfactory fluidization was achieved, water vapor was introduced into the reactor through the base glass frit using a stream of nitrogen carrier gas passed through a water bubbler. The metal oxide precursor compounds (either SiCl₄ or TiCl₄) were vaporized by passing nitrogen carrier gas through a bubbler containing the neat liquid precursor and introducing the vaporized compounds into the reactor through a glass tube extending downward into the fluidized bead bed.

For retroreflective elements having multiple coatings, the additional layers were deposited by repeating the procedure for each additional complete concentric optical interference layer.

Flow rates of the reactant-laden carrier gases and reaction temperatures for silica and titania coatings are reported in Table 1.

TABLE 1

| | | | | | Extra |
|---|---|---|---|---|---|
| | | | Precursor | Water | Nitrogen |
| | Reaction | | bubbler | bubbler | flow |
| Type of | Temp | | flow rate | flow rate | rate |
| coating | (° C.) | Precursor | (cc/min) | (cc/min) | (cc/min) |
| SiO₂ | 40 | SiCl₄ | 40 | 600 | 500 |
| TiO₂ | 140 | TiCl₄ | 600 | 600 | 500 |

In some instances, samples of different coating thicknesses were made by varying the coating times. This was accomplished by removing a small volume of retroreflective elements from the reactor at different times. Coating rates were determined by fracturing certain concentrically coated glass retroreflective elements that had been sampled from the reactor at known coating deposition times and examining the fracture pieces with a scanning electron microscope to directly measure the coating thicknesses. Thereafter, the thicknesses of the concentric coatings were calculated from known coating times and coating rates. A coating rate of ˜2 nm/min was typical for the silica coatings, and a coating rate of ˜5 nm/min was typical for the titania coatings.

### Procedure B: Patch Brightness

Measurements of retroreflected brightness include “patch brightness” measurements of the coefficient of retroreflection (Ra) of a layer of retroreflective elements. Clear Patch Brightness as well as White Patch Brightness measurements were made. Clear Patch Brightness results are designated herein as “Ra (CP)” and White Patch Brightness results are designated as “Ra (WP).” In either case, layers of retroreflective elements were made by sprinkling retroreflective elements onto an adhesive tape and placing the construction under a retroluminometer. For Clear Patch Brightness, sample constructions were prepared by partially embedding the retroreflective elements in the adhesive of a transparent tape (3M Scotch 375 Clear Tape) and placing the tape on top of a sheet of paper having a dark (black) background. White Patch Brightness sample constructions were prepared by partially embedding the retroreflective elements in the adhesive of a tape in which the adhesive was pigmented with titanium dioxide to impart a white color. Retroreflective elements were typically embedded so that <50% of the retroreflective element diameter was sunk in the adhesive. For each of the Patch Brightness constructions, the Ra in Cd/m²/lux was determined according to the procedure established in Procedure B of ASTM Standard E 809-94a, measured at an entrance angle of −4.0 degrees and an observation angle of 0.2 degrees. The photometer used for those measurements is described in U.S. Defensive Publication No. T987,003.

### Procedure C: Color Measurements

The retroreflective color or retrochromic effects were quantified by measuring color coordinates using an optical spectrometer (MultiSpec Series System with an MCS UV-NIR spectrometer and 50 watt halogen light source and bifurcated optical fiber probe, commercially available from TecS AG, Oberursol, Germany). Concentrically coated retroreflective elements were partially embedded in the adhesive of a commercially available tape (3M Scotch 375 Clear Tape). The embedded retroreflective elements were placed under a fiber optic probe at a distance of ˜5 mm, and spectral measurements were made in the wavelength range 300 nm-1050 nm using a black background. A front surface mirror was used as the reference, and all measurements were normalized. Chromaticity coordinates were calculated from the reflectance spectra using (MultiSpec® Pro software with color module, commercially available from TecS AG, Oberursol, Germany). Color coordinates were measured for retroreflective elements made according to certain Comparative Examples and certain Examples, as specified herein. A CIE chromaticity diagram (1931 version) was referenced as well as a standard black body curve. The black body curve passes through white between approximately 4800K and 7500K. The corresponding color coordinates at these temperatures are (0.353, 0.363) and (0.299, 0.317). Measurements made from retroreflective elements showing little or no visible color in retroreflection lay within 0.01 of the black body radiation curve between 4800K and 7500K. It should be noted that the (x, y) coordinates correspond to the 1964 10 degree field of view modification to the original 1931 coordinates. The CIE chart and black body radiation curves are described in Zukauskas et al., Introduction to Solid State Lighting, John Wiley and Sons (2002); Chapter 2 (Vision, Photometry, and Colorimetry), pp. 7-15.

### Comparative Example 1 and Examples 2-44

The bead cores used in the preparation of Comparative Example 1 and Examples 2-44 are referred to herein as Type I bead cores which were transparent glass beads having a refractive index of about 1.93, an average diameter of about 60 μm, and an approximate composition of 42.5% TiO₂, 29.4% BaO, 14.9% SiO₂, 8.5% Na₂O, 3.3% B₂O₃, and 1.4% K₂O by weight. Comparative Example 1 was an uncoated Type I bead core. Examples 2-44 were prepared according to the above Procedure A to have a single complete concentric interference layer. For Examples 2-25, the single complete concentric interference layer was silica while Examples 26-44 had a single complete concentric interference layer of titania. Coating times, calculated coating thicknesses, and retroreflected brightness (Ra) of Clear Patch constructions made with the bead cores are reported in Table 2.

TABLE 2

| | | | Estimated | |
|---|---|---|---|---|
| | | Coating | coating | |
| | Coating | time | thickness | |
| Sample | material | (min) | (nm) | Ra (CP) |
| C. Ex. 1 | none | uncoated | uncoated | 7.7 |
| Ex. 2 | SiO₂ | 18 | 36 | 9.76 |
| Ex. 3 | SiO₂ | 22 | 44 | 10.5 |
| Ex. 4 | SiO₂ | 26 | 52 | 11.7 |
| Ex. 5 | SiO₂ | 31 | 62 | 12.8 |
| Ex. 6 | SiO₂ | 34 | 68 | 13.5 |
| Ex. 7 | SiO₂ | 37 | 74 | 14.4 |
| Ex. 8 | SiO₂ | 40 | 80 | 15.1 |
| Ex. 9 | SiO₂ | 44 | 88 | 16.1 |
| Ex. 10 | SiO₂ | 48 | 96 | 17 |
| Ex. 11 | SiO₂ | 52 | 104 | 17.5 |
| Ex. 12 | SiO₂ | 55 | 110 | 17.1 |
| Ex. 13 | SiO₂ | 58 | 116 | 17 |
| Ex. 14 | SiO₂ | 61 | 122 | 15.3 |
| Ex. 15 | SiO₂ | 63 | 126 | 14.7 |
| Ex. 16 | SiO₂ | 65 | 130 | 13.2 |
| Ex. 17 | SiO₂ | 67 | 134 | 12.3 |
| Ex. 18 | SiO₂ | 69 | 138 | 11.1 |
| Ex. 19 | SiO₂ | 71 | 142 | 10.2 |
| Ex. 20 | SiO₂ | 73 | 146 | 9.3 |
| Ex. 21 | SiO₂ | 76 | 152 | 8.6 |
| Ex. 22 | SiO₂ | 78 | 156 | 8.2 |
| Ex. 23 | SiO₂ | 81 | 162 | 8.16 |
| Ex. 24 | SiO₂ | 84 | 168 | 8.55 |
| Ex. 25 | SiO₂ | 88 | 176 | 9.3 |
| Ex. 26 | TiO₂ | 6 | 30 | 18.5 |
| Ex. 27 | TiO₂ | 10 | 50 | 26.7 |
| Ex. 28 | TiO₂ | 13 | 65 | 30.1 |
| Ex. 29 | TiO₂ | 19 | 95 | 27.9 |
| Ex. 30 | TiO₂ | 22 | 110 | 22.7 |
| Ex. 31 | TiO₂ | 26 | 130 | 13.9 |
| Ex. 32 | TiO₂ | 30 | 150 | 16.1 |
| Ex. 33 | TiO₂ | 32 | 160 | 17.5 |
| Ex. 34 | TiO₂ | 38 | 190 | 21.3 |
| Ex. 35 | TiO₂ | 40 | 200 | 21.1 |
| Ex. 36 | TiO₂ | 42 | 210 | 17.9 |
| Ex. 37 | TiO₂ | 45 | 225 | 17.7 |
| Ex. 38 | TiO₂ | 48 | 240 | 17.8 |
| Ex. 39 | TiO₂ | 50 | 250 | 18.1 |
| Ex. 40 | TiO₂ | 53 | 265 | 17.7 |
| Ex. 41 | TiO₂ | 55 | 275 | 18.4 |
| Ex. 42 | TiO₂ | 58 | 290 | 17.6 |
| Ex. 43 | TiO₂ | 60 | 300 | 18.6 |
| Ex. 44 | TiO₂ | 65 | 325 | 18.6 |

Retroreflective color was assessed for Comparative Example 1 and Example 6, 9, 11 and 13 according to Procedure C. Table 2A lists the color coordinates, observed color, distance from black body radiation curve between 4800K and 7500K and the coordinates for the closest point on the black body radiation curve between 4800K and 7500K. The designation “L/N” indicates little or no color was observed.

TABLE 2A

| | | | Distance from | Closest point on |
|---|---|---|---|---|
| | Chromaticity | | black body | black body curve |
| | coordinate | | radiation curve | (x, y), between |
| | measurements | Observed | between 4800K | 4800K and |
| Sample | (x, y) | color | and 7500K | 7500K |
| C. Ex. 1 | 0.327, 0.34 | L/N | 0.0018 | 0.326, 0.341 |
| Ex. 6 | 0.318, 0.334 | L/N | 0.0004 | 0.318, 0.334 |
| Ex. 9 | 0.331, 0.346 | L/N | 0.0012 | 0.332, 0.347 |
| Ex. 11 | 0.341, 0.355 | L/N | 0.001 | 0.342, 0.355 |
| Ex. 13 | 0.344, 0.356 | L/N | 0.0007 | 0.344, 0.357 |

### Examples 45-69

Examples 45-69 employ the Type I bead cores. The coated retroreflective elements were prepared according to Procedure A so that the coated retroreflective elements included two concentric optical interference layers. Examples 45-60 were made using Type I bead cores coated with an inner or first optical interference layer of silica and an outer or second optical interference layer of titania. Examples 61-69 were made with Type I bead cores and were coated with an inner or first optical interference layer of titania and an outer or second optical interference layer of silica. Coating materials, thicknesses, and retroreflected brightness (Ra) of clear patch constructions are reported in Table 3.

TABLE 3

| | | Estimated | | Estimated | |
|---|---|---|---|---|---|
| | Inner | inner | Outer | outer | |
| | layer | layer | layer | layer | |
| | coating | thickness | coating | thickness | |
| Example | material | (nm) | material | (nm) | Ra (CP) |
| 45 | SiO₂ | 110 | TiO₂ | 30 | 46.1 |
| 46 | SiO₂ | 110 | TiO₂ | 50 | 56.4 |
| 47 | SiO₂ | 110 | TiO₂ | 60 | 58.4 |
| 48 | SiO₂ | 110 | TiO₂ | 80 | 56.7 |
| 49 | SiO₂ | 110 | TiO₂ | 100 | 56.6 |
| 50 | SiO₂ | 110 | TiO₂ | 125 | 51 |
| 51 | SiO₂ | 110 | TiO₂ | 150 | 42 |
| 52 | SiO₂ | 110 | TiO₂ | 165 | 35.2 |
| 53 | SiO₂ | 110 | TiO₂ | 180 | 32.7 |
| 54 | SiO₂ | 110 | TiO₂ | 200 | 35.9 |
| 55 | SiO₂ | 110 | TiO₂ | 215 | 41.7 |
| 56 | SiO₂ | 40 | TiO₂ | 50 | 31.2 |
| 57 | SiO₂ | 40 | TiO₂ | 75 | 42.4 |
| 58 | SiO₂ | 40 | TiO₂ | 100 | 44.4 |
| 59 | SiO₂ | 40 | TiO₂ | 125 | 28.5 |
| 60 | SiO₂ | 40 | TiO₂ | 135 | 27.1 |
| 61 | TiO₂ | 60 | SiO₂ | 40 | 40.1 |
| 62 | TiO₂ | 60 | SiO₂ | 50 | 45.4 |
| 63 | TiO₂ | 60 | SiO₂ | 60 | 49.4 |
| 64 | TiO₂ | 60 | SiO₂ | 70 | 51.6 |
| 65 | TiO₂ | 60 | SiO₂ | 80 | 51.3 |
| 66 | TiO₂ | 60 | SiO₂ | 90 | 47.1 |
| 67 | TiO₂ | 60 | SiO₂ | 100 | 43.8 |
| 68 | TiO₂ | 60 | SiO₂ | 110 | 37.4 |
| 69 | TiO₂ | 60 | SiO₂ | 120 | 26.1 |

Retroreflective color was assessed for Examples 45, 47, 49, 50, 52, 54 and 55 according to Procedure C. Table 3A lists the color coordinates, observed color, distance from black body radiation curve between 4800K and 7500K and the coordinates for the closest point on the black body radiation curve between 4800K and 7500K. The designation “L/N” indicates little or no color was observed.

TABLE 3A

| | | | | Closest |
|---|---|---|---|---|
| | | | | point on |
| | | | Distance from | black body |
| | Chromaticity | | black body | curve (x, y) |
| | coordinate | | radiation curve | between |
| | measurements | Observed | between 4800K | 4800K and |
| Example | (x, y) | color | and 7500K | 7500K |
| 45 | 0.322, 0.347 | L/N | 0.0068 | 0.326, 0.341 |
| 47 | 0.343, 0.358 | L/N | 0.0017 | 0.344, 0.357 |
| 49 | 0.365, 0.382 | light yellow | 0.0225 | 0.353, 0.363 |
| 50 | 0.384, 0.393 | yellow | 0.0431 | 0.353, 0.363 |
| 52 | 0.34, 0.312 | purple | 0.0314 | 0.32, 0.336 |
| 54 | 0.292, 0.332 | light blue | 0.0158 | 0.302, 0.320 |
| 55 | 0.313, 0.363 | light green | 0.0248 | 0.33, 0.345 |

### Examples 70-80

Examples 70-80 employed Type I bead cores as well as the same coating materials and used for the preparation of Examples 1-44. The coated retroreflective elements were prepared according to Procedure A with Examples 70-80 made to include three complete concentric interference layers. Coating materials, thicknesses, and retroreflected brightness (Ra) of clear patch constructions are reported in Table 4.

TABLE 4

| | | Inner | | Second | | Outer | |
|---|---|---|---|---|---|---|---|
| Ex- | | layer | | layer | | layer | |
| am- | Inner | thickness | Second | thickness | Outer | thickness | Ra |
| ple | layer | (nm) | layer | (nm) | layer | (nm) | (CP) |
| 70 | SiO₂ | 110 | TiO₂ | 60 | SiO₂ | 32 | 63 |
| 71 | SiO₂ | 110 | TiO₂ | 60 | SiO₂ | 52 | 79.1 |
| 72 | SiO₂ | 110 | TiO₂ | 60 | SiO₂ | 72 | 102 |
| 73 | SiO₂ | 110 | TiO₂ | 60 | SiO₂ | 92 | 113 |
| 74 | SiO₂ | 110 | TiO₂ | 60 | SiO₂ | 98 | 113 |
| 75 | SiO₂ | 110 | TiO₂ | 60 | SiO₂ | 106 | 109 |
| 76 | SiO₂ | 110 | TiO₂ | 60 | SiO₂ | 112 | 102 |
| 77 | SiO₂ | 110 | TiO₂ | 60 | SiO₂ | 116 | 95.1 |
| 78 | SiO₂ | 40 | TiO₂ | 110 | SiO₂ | 10 | 24 |
| 79 | SiO₂ | 40 | TiO₂ | 110 | SiO₂ | 20 | 26.9 |
| 80 | SiO₂ | 40 | TiO₂ | 110 | SiO₂ | 36 | 31.1 |

Retroreflective color was assessed according to Procedure C for Examples 70 and 72-75. Table 4A lists the color coordinates, observed color, distance from black body radiation curve between 4800K and 7500K and the coordinates of the closest point on the black body radiation curve between 4800K and 7500K. The designation “L/N” indicates little or no color was observed.

TABLE 4A

| | | | Distance | |
|---|---|---|---|---|
| | | | from | Closest |
| | | | black body | point on |
| | | | radiation | black body |
| | Chromaticity | | curve | curve (x, y) |
| | coordinate | | between | between |
| | measurements | Observed | 4800K | 4800K and |
| Example | (x, y) | color | and 7500K | 7500K |
| 70 | 0.332, 0.352 | L/N | 0.0042 | 0.334, 0.348 |
| 72 | 0.341, 0.372 | light yellow | 0.0138 | 0.35, 0.362 |
| 73 | 0.371, 0.394 | yellow | 0.036 | 0.353, 0.363 |
| 74 | 0.385, 0.399 | yellow-orange | 0.0487 | 0.353, 0.363 |
| 75 | 0.4, 0.394 | orange | 0.057 | 0.353, 0.363 |

### Comparative Example 81 and Examples 82-104

Comparative Example 81 and Examples 82-104 were prepared in the same manner as in Comparative Example 1 and Examples 2-15 and 45-53, respectively. Retroreflective color from these coated retroreflective element samples was observed and recorded. Observed retroreflective color was determined by viewing through a retroreflective viewer (available under the trade designation “3M VIEWER” from 3M Company, St. Paul, Minn.). A layer of retroreflective elements was partially embedded in a polymer adhesive (3M Scotch 375 Clear Tape) to determine Clear Patch brightness. Table 5 summarizes the construction, observed retroreflective color and Clear Patch Brightness for the samples.

TABLE 5

| | | Inner | | Outer | | Retroreflective |
|---|---|---|---|---|---|---|
| | | layer | | layer | | color from clear |
| | Inner | thickness | Outer | thickness | | patch |
| Sample | layer | (nm) | layer | (nm) | Ra (CP) | constructions |
| C. Ex. 81 | uncoated | uncoated | uncoated | uncoated | 7.7 | L/N |
| Ex. 82 | SiO₂ | 36 | none | 0 | 9.76 | L/N |
| Ex. 83 | SiO₂ | 44 | none | 0 | 10.5 | L/N |
| Ex. 84 | SiO₂ | 52 | none | 0 | 11.7 | L/N |
| Ex. 85 | SiO₂ | 62 | none | 0 | 12.8 | L/N |
| Ex. 86 | SiO₂ | 68 | none | 0 | 13.5 | L/N |
| Ex. 87 | SiO₂ | 74 | none | 0 | 14.4 | L/N |
| Ex. 88 | SiO₂ | 80 | none | 0 | 15.1 | orange |
| Ex. 89 | SiO₂ | 88 | none | 0 | 16.1 | rust |
| Ex. 90 | SiO₂ | 96 | none | 0 | 17 | purple |
| Ex. 91 | SiO₂ | 104 | none | 0 | 17.5 | violet |
| Ex. 92 | SiO₂ | 110 | none | 0 | 17.1 | bluish violet |
| Ex. 93 | SiO₂ | 116 | none | 0 | 17 | blue |
| Ex. 94 | SiO₂ | 122 | none | 0 | 15.3 | blue |
| Ex. 95 | SiO₂ | 126 | none | 0 | 14.7 | bluish green |
| Ex. 96 | SiO₂ | 110 | TiO₂ | 30 | 46.1 | L/N |
| Ex. 97 | SiO₂ | 110 | TiO₂ | 50 | 56.4 | L/N |
| Ex. 98 | SiO₂ | 110 | TiO₂ | 60 | 58.4 | L/N |
| Ex. 99 | SiO₂ | 110 | TiO₂ | 80 | 56.7 | L/N |
| Ex. 100 | SiO₂ | 110 | TiO₂ | 100 | 56.6 | creamish yellow |
| Ex. 101 | SiO₂ | 110 | TiO₂ | 125 | 51 | yellow |
| Ex. 102 | SiO₂ | 110 | TiO₂ | 165 | 35.2 | red |
| Ex. 103 | SiO₂ | 110 | TiO₂ | 180 | 32.7 | purple |
| Ex. 104 | SiO₂ | 110 | TiO₂ | 215 | 35.9 | violet |

* L/N - little or no color observed in retroreflection

### Comparative Example 105 and Examples 106-110

White patch brightness measurements were made for several of the previously described coated retroreflective element samples. Table 6 summarizes the construction of the coated retroreflective elements as well as White Patch Brightness for these samples.

TABLE 6

| | | | Outer | Estimated | |
|---|---|---|---|---|---|
| | Coated as | | layer | outer layer | |
| | in | | coating | thickness | Ra |
| Sample | Example | Layer sequence | material | (nm) | (WP) |
| C. Ex. | 1 | none | uncoated | uncoated | 18.1 |
| 105 | | | | | |
| Ex. 106 | 11 | SiO₂ | SiO₂ | 104 | 23.6 |
| Ex. 107 | 28 | TiO₂ | TiO₂ | 150 | 40.1 |
| Ex. 108 | 47 | SiO₂, TiO₂ | TiO₂ | 60 | 67 |
| Ex. 109 | 73 | SiO₂, TiO₂, SiO₂ | SiO₂ | 98 | 114 |
| Ex. 110 | 80 | SiO₂, TiO₂, SiO₂ | SiO₂ | 36 | 33 |

### Comparative Example 111 and Examples 112-123

Glass-ceramic bead cores were prepared according to the methods described in U.S. Pat. No. 6,245,700. The Type II bead cores had a composition of ZrO₂ 12.0%, Al₂O₃ 29.5%, SiO₂ 16.2%, TiO₂ 28.0%, MgO 4.8%, CaO 9.5% (wt %), with a refractive index of ˜1.89 and an average diameter about 60 um. The bead cores were coated with a single layer SiO₂ or TiO₂ according to Procedure A. The construction of the coated retroreflective elements and both Clear Patch Brightness and White Patch Brightness determinations are reported in Table 7.

TABLE 7

| | | Estimated | | |
|---|---|---|---|---|
| | | coating | | |
| | Coating | thickness | | |
| Sample | material | (nm) | Ra (CP) | Ra (WP) |
| C. Ex. 111 | uncoated | uncoated | 3.1 | 15.2 |
| Ex. 112 | SiO₂ | 20 | 5.6 | 16.8 |
| Ex. 113 | SiO₂ | 36 | 4.71 | 16.2 |
| Ex. 114 | SiO₂ | 50 | 5.08 | 16.1 |
| Ex. 115 | SiO₂ | 64 | 5.45 | 16.4 |
| Ex. 116 | SiO₂ | 78 | 5.6 | 16.3 |
| Ex. 117 | SiO₂ | 92 | 5.7 | 17.6 |
| Ex. 118 | SiO₂ | 106 | 6.22 | 16.3 |
| Ex. 119 | TiO₂ | 40 | 11 | 19.3 |
| Ex. 120 | TiO₂ | 65 | 14.4 | 21.4 |
| Ex. 121 | TiO₂ | 95 | 12.1 | 23 |
| Ex. 122 | TiO₂ | 120 | 6.5 | 17.6 |
| Ex. 123 | TiO₂ | 150 | 6.4 | 16.8 |

### Examples 124-137

Type II bead cores were coated with two and three complete concentric optical interference layers, according to Procedure A. Tables 8 summarizes the coating materials, coating thicknesses and Clear Patch Brightness and White Patch Brightness measurements for the retroreflective elements having two coated layers. Table 9 summarizes the coating materials, coating thicknesses and Clear Patch Brightness and White Patch Brightness measurements for the retroreflective elements having three coated layers.

TABLE 8

| | Inner | Estimated | Outer | Estimated | | |
|---|---|---|---|---|---|---|
| | layer | inner layer | layer | outer layer | | |
| | coating | thickness | coating | thickness | | Ra |
| Example | material | (nm) | material | (nm) | Ra (CP) | (WP) |
| 124 | SiO₂ | 100 | TiO₂ | 15 | 11.3 | |
| 125 | SiO₂ | 100 | TiO₂ | 40 | 15.5 | 26.1 |
| 126 | SiO₂ | 100 | TiO₂ | 60 | 17.3 | 27.5 |
| 127 | SiO₂ | 100 | TiO₂ | 85 | 16.3 | 26.9 |
| 128 | SiO₂ | 100 | TiO₂ | 120 | 14.6 | 21.9 |
| 129 | SiO₂ | 100 | TiO₂ | 155 | 13.6 | |
| 130 | SiO₂ | 100 | TiO₂ | 185 | 12.4 | 23.3 |

TABLE 9

| | | Estimated | | Estimated | | Estimated | | |
|---|---|---|---|---|---|---|---|---|
| | First | first | Second | second | Outer | outer | | |
| | layer | layer | layer | layer | layer | layer | | |
| | coating | thickness | coating | thickness | coating | thickness | | |
| Example | material | (nm) | material | (nm) | material | (nm) | Ra (CP) | Ra (WP) |
| 131 | SiO₂ | 110 | TiO₂ | 60 | SiO₂ | 70 | 29.6 | |
| 132 | SiO₂ | 110 | TiO₂ | 60 | SiO₂ | 80 | 33.4 | |
| 133 | SiO₂ | 110 | TiO₂ | 60 | SiO₂ | 90 | 36.5 | |
| 134 | SiO₂ | 110 | TiO₂ | 60 | SiO₂ | 100 | 38.1 | |
| 135 | SiO₂ | 110 | TiO₂ | 60 | SiO₂ | 110 | 38.2 | 42.5 |
| 136 | SiO₂ | 110 | TiO₂ | 60 | SiO₂ | 120 | 40.8 | 46.5 |
| 137 | SiO₂ | 110 | TiO₂ | 60 | SiO₂ | 126 | 37.2 | |

### Example 138

Three complete concentric optical interference coatings were deposited on transparent beads having a composition of ZrO₂ 23.8%, Al₂O₃ 30.2%, La₂O₃ 25.0%, TiO₂ 10.4%, CaO 10.6% (wt %), using Procedure A. Table 10 summarizes the coating materials, coating thicknesses, and retroreflective Clear Patch Brightness and White Patch Brightness measurements.

TABLE 10

| | | Estimated | | Estimated | | Estimated | | |
|---|---|---|---|---|---|---|---|---|
| | First | first | Second | second | Outer | outer | | |
| | layer | layer | layer | layer | layer | layer | | |
| | coating | thickness | coating | thickness | coating | thickness | | |
| Example | material | (nm) | material | (nm) | material | (nm) | Ra (CP) | Ra (WP) |
| 138 | SiO₂ | 110 | TiO₂ | 60 | SiO₂ | 100 | 47.1 | 49.9 |

### Comparative Example 139 and Examples 140-160

Bead cores designated as Type III were prepared according to the methods described in U.S. Pat. No. 6,245,700. The Type III bead cores were made of a glass-ceramic material having a composition of TiO₂ 61.3%, ZrO₂ 7.6%, La₂O₃ 29.1%, ZnO 2% by weight, with RI˜2.4, and an average diameter of about 60 um. The bead cores were coated with single layer coatings of SiO₂ or TiO₂ according to Procedure A. Clear Patch Brightness and White Patch Brightness measurements were recorded by covering the patch surface with water. Coating materials, coating thicknesses and the wet White Patch and wet Clear Patch Brightness measurements are summarized in Table 11.

TABLE 11

| | Coating | Coating | | |
|---|---|---|---|---|
| Sample | material | thickness (nm) | Wet Ra (CP) | Wet Ra (WP) |
| C. Ex. 139 | uncoated | 0 | 3.91 | 11.4 |
| Ex. 140 | SiO₂ | 36 | 4.8 | 11.5 |
| Ex. 141 | SiO₂ | 48 | 5.03 | 12.2 |
| Ex. 142 | SiO₂ | 60 | 5.3 | |
| Ex. 143 | SiO₂ | 72 | 5.83 | 13.6 |
| Ex. 144 | SiO₂ | 84 | 6.04 | |
| Ex. 145 | SiO₂ | 96 | 6.48 | 13.4 |
| Ex. 146 | SiO₂ | 108 | 6.54 | 13.5 |
| Ex. 147 | SiO₂ | 120 | 6.7 | 12.9 |
| Ex. 148 | SiO₂ | 132 | 5.7 | |
| Ex. 149 | SiO₂ | 144 | 6.09 | |
| Ex. 150 | SiO₂ | 156 | 5.44 | |
| Ex. 151 | SiO₂ | 168 | 5.1 | |
| Ex. 152 | SiO₂ | 180 | 4.5 | |
| Ex. 153 | TiO₂ | 30 | 4.12 | 11 |
| Ex. 154 | TiO₂ | 60 | 3.7 | 9.51 |
| Ex. 155 | TiO₂ | 90 | 2.73 | 11.7 |
| Ex. 156 | TiO₂ | 120 | 2.79 | 10.7 |
| Ex. 157 | TiO₂ | 162 | 3.6 | 11.6 |
| Ex. 158 | TiO₂ | 198 | 4.6 | 10.9 |
| Ex. 159 | TiO₂ | 240 | 3.75 | |
| Ex. 160 | TiO₂ | 288 | 3.1 | |

### Example 161

Three complete concentric optical interference layers were deposited on Type III cores according to Procedure A. Table 12 summarizes the coating materials, coating thicknesses and White Patch and Clear Patch Brightness measurements. The White Patch and Clear Patch Brightness measurements were made under wet conditions as in Examples 139-160.

TABLE 12

| | Inner | Inner | Second | Second | Outer | Outer | | |
|---|---|---|---|---|---|---|---|---|
| | layer | layer | layer | layer | layer | layer | | |
| | coating | thickness | coating | thickness | coating | thickness | Wet Ra | Wet Ra |
| Example | material | (nm) | material | (nm) | material | (nm) | (CP) | (WP) |
| 161 | SiO₂ | 120 | TiO₂ | 60 | SiO₂ | 110 | 11.3 | 17.2 |

### Comparative Examples 162, 164, 166, and 168 and Examples 163, 165, 167, and 169

The samples included coated and uncoated bead cores, including uncoated Type II bead cores along with three layer complete concentric coated Type II (as in Comparative Example 111 and Example 136) and Type III retroreflective element cores (as in Comparative Example 139 and Example 161). A 254 micrometer spread of either titania or pearl pigmented (27 wt. %, DuPont Ti-Pure titania or Merck Industries IRIODIN 9119 pearl pigment) polyurethane on a polyester film was first pulled, and the polyurethane spread was placed on top of 3M Stamark 380 Wet reflective tape to prove a surface profile. A rubber hand roller was then used to squeeze the pigmented polyurethane onto the edges of the profiles, which was followed by removal of the polyester film. Retroreflective elements were surface treated by exposure to a solution of 600 ppm A1100 and 125 ppm Krytox surface agents, which act as a coupling agent and a float aid to prevent the polyurethane from wicking over the retroreflective elements, respectively. The retroreflective elements were poured on one end of the profiled tape and cascade coated onto the tape twice. The samples were cured overnight at room temperature and then at 149° C. for 2 minutes. Table 13 describes the tape samples made and the corresponding binder used. Retroreflectivity of the tape samples were measured using an LTL-X Retrometer (Delta—Horshlom Denmark). Up web and down web measurements were taken. Up and down web refer to the coating direction during fabrication of the samples. Up web is in the direction of the uncoated portion. Downweb is in the direction of the coated portion. Retrometer measurements of wet samples were made during continuous exposure to water and 45 seconds after exposure according to ASTM tests 2176 and 2177, respectively. Table 14 lists the retroreflective brightness measurements made by using the retrometer. Data showed concentrically coated Type II retroreflective element cores to produce significant increases (˜1.5-2.5×) in retroreflective brightness of tape constructions, both with pearlescent and TiO₂ pigments.

TABLE 13

| | Bead Type/ | |
|---|---|---|
| | Source | Binder Type |
| Comparative | | |
| Example | | |
| 162 | Std. White Type II | Pearl Pigmented |
| | bead cores | Polyurethane |
| 164 | Std. White Type III | Pearl Pigmented |
| | bead cores | Polyurethane |
| 166 | Std. White Type II | TiO₂ Pigmented |
| | bead cores | Polyurethane |
| 168 | Std. White Type III | TiO₂ Pigmented |
| | bead cores | Polyurethane |
| Example | | |
| 163 | (3) Layer Coated | Pearl Pigmented |
| | Type II bead cores | Polyurethane |
| 165 | (3) Layer Coated | Pearl Pigmented |
| | Type III bead cores | Polyurethane |
| 167 | (3) Layer Coated | TiO₂ Pigmented |
| | Type II bead cores | Polyurethane |
| 169 | (3) Layer Coated | TiO₂ Pigmented |
| | Type III bead cores | Polyurethane |

TABLE 14

| | Dry LTLX Measurements | | | | | | | | | |
|---|---|---|---|---|---|---|---|---|---|---|
| | Up Web | | | | Down Web | | | | | |
| | Measurements | | | | Measurements | | | | Wet LTLX Measurements | |
| Sample | 1 | 2 | 3 | Avg. | 1 | 2 | 3 | Avg. | Continuous | 45 Sec. Recovery |
| C. Ex. 162 | 2719 | 2791 | 2829 | 2780 | 2548 | 2365 | 2341 | 2418 | | |
| Ex. 163 | >3500 | >3500 | 3491 | 3497 | 3280 | 3495 | 3332 | 3369 | | |
| C. Ex. 164 | 227 | 218 | 193 | 213 | 212 | 157 | 167 | 179 | 687 | 1007 |
| Ex. 165 | 209 | 199 | 184 | 197 | 162 | 164 | 157 | 161 | 758 | 956 |
| C. Ex. 166 | 1245 | 1171 | 977 | 1131 | 1168 | 1180 | 931 | 1093 | | |
| Ex. 167 | 2561 | 2816 | 2348 | 2575 | 2426 | 2572 | 2375 | 2458 | | |
| C. Ex. 168 | 244 | 244 | 239 | 242 | 227 | 233 | 226 | 229 | 325 | 469 |
| Ex. 169 | 228 | 233 | 219 | 227 | 224 | 202 | 187 | 204 | 447 | 559 |

Embodiments of the invention have been described in some detail. Those skilled in the art will appreciate that the invention is not limited to the described embodiments, and that various changes and modifications can be made to the embodiments without departing from the spirit and scope of the invention.

1-28. (canceled)

29. A pavement marking, comprising:
A substrate having a first major surface and a second major surface; and
A plurality of retroreflective elements disposed along the first major surface of the substrate, the retroreflective elements each comprising:
a solid spherical core comprising an outer core surface, the outer core surface providing a first interface;
at least a first complete concentric optical interference layer having an inner surface overlying the outer core surface and an outer surface, the outer surface of the first complete concentric optical interference layer providing a second interface, the pavement marking being retroreflective.

30. The pavement marking according to claim 29, having a retroreflective color with chromaticity coordinates defining a point on the CIE chromaticity diagram (1931 version) that lies within 0.01 of the line that describes black body emission between 4800K and 7500K.

31. The pavement marking according to claim 29, wherein the retroreflective elements each further comprise:
a second complete concentric optical interference layer having an inner surface overlying the outer surface of the first complete concentric optical interference layer and an outer surface, the outer surface of the second complete concentric optical interference layer providing a third interface.

32. The pavement marking according to claim 31 wherein the first complete concentric optical interference layer and the second complete concentric optical interference layer comprise different materials, each of the materials selected from the group consisting of TiO₂, SiO₂, ZnS, CdS, CeO₂, ZrO₂, Bi₂O₃, ZnSe, WO₃, PbO, ZnO, Ta₂O₅, Al₂O₃, B₂O₃, MgO, AlF₃, CaF₂, CeF₃, LiF, MgF₂, Na₃AlF₆, and combinations of two or more of the foregoing.

33. The pavement marking according to claim 32, wherein the retroreflective elements each further comprise:
third complete concentric optical interference layer having an inner surface overlying the outer surface of the second complete concentric optical interference layer and an outer surface, the outer surface of the third complete concentric optical interference layer providing a fourth interface.

34. The pavement marking according to claim 33, wherein the second complete concentric optical interference layer and the third complete concentric optical interference layer comprise different materials, each of the materials selected from the group consisting of TiO₂, SiO₂, ZnS, CdS, CeO₂, ZrO₂, Bi₂O₃, ZnSe, WO₃, PbO, ZnO, Ta₂O₅, Al₂O₃, B₂O₃, MgO, AlF₃, CaF₂, CeF₃, LiF, MgF₂, Na₃AlF₆, and combinations of two or more of the foregoing.

35. The pavement marking according to claim 29, further comprising a binder disposed on the first major surface of the substrate, the retroreflective elements embedded in the binder to a depth corresponding to between 10% and 90% of the diameter of the retroreflective elements.

36. The pavement marking according to claim 35 wherein the binder further comprises filler particles selected from the group consisting of nacreous pigment, pearlescent pigment, specular pigment and combinations of two or more of the foregoing.

37. The pavement marking according to claim 29, wherein the solid spherical core has a refractive index within the range from 1.5 to 2.1.

38. The pavement marking according to claim 29, wherein the solid spherical core has a refractive index within the range from 2.0 to 2.6.

39. The pavement marking according to claim 29, wherein the substrate comprises a polymeric sheet comprising a base and a plurality of protrusions extending from the base, the protrusions comprising side surfaces extending from the base and a rounded top surface, the retroreflective elements affixed to the base and to the side surfaces and top surface of the protrusions.

40. The pavement marking of claim 29, wherein the marking exhibits interference-enhanced retroreflective brightness, wherein the article exhibits a coefficient of retroreflection value at least 1.3 times greater than that of an otherwise identical article comprising retroreflective elements consisting of the solid spherical core having no complete concentric optical interference layers thereon.

41. The pavement marking according to claim 29 wherein the retroreflective elements further comprise a portion thereof comprised of a second complete concentric optical interference layer having an inner surface overlying the outer surface of the first complete concentric optical interference layer and an outer surface, the outer surface of the second complete concentric optical interference layer providing a third interface.

42. The pavement marking according to claim 41, wherein the first complete concentric optical interference layer and the second complete concentric optical interference layer comprise different materials selected from the group consisting of silica and titania.

43. The pavement marking of claim 42, wherein the marking exhibits interference-enhanced retroreflective brightness, wherein the article exhibits a coefficient of retroreflection value at least 1.3 times greater than that of an otherwise identical article comprising retroreflective elements consisting of the solid spherical core having no complete concentric optical interference layers thereon.

44. The pavement marker of claim 42, wherein the pavement marking exhibits retroreflective color.

45. The pavement marking according to claim 41, wherein the retroreflective elements comprise another portion thereof having the first optical interference layer and the second optical interference layer and further comprising a third complete concentric optical interference layer having an inner surface overlying the outer surface of the second complete concentric optical interference layer and an outer surface, the outer surface of the third complete concentric optical interference layer providing a fourth interface.

46. The pavement marking according to claim 45, wherein the first complete concentric optical interference layer, the second complete concentric optical interference layer and the third complete concentric optical interference layer comprise alternating layers of silica and titania.

47. The pavement marking of claim 46, wherein the marking exhibits interference-enhanced retroreflective brightness, wherein the article exhibits a coefficient of retroreflection value at least 1.3 times greater than that of an otherwise identical article comprising retroreflective elements consisting of the solid spherical core having no complete concentric optical interference layers thereon.

48. The pavement marker of claim 46, wherein the pavement marking exhibits retroreflective color.

49. The pavement marker according to claim 29, wherein the second major surface of the substrate further comprises an adhesive suitable for affixing the pavement marking to pavement.
